(19) United States
(12) Patent Application Publication
(10) Pub. No.: US 2013/0294705 A1
(43) Pub. Date: Nov. 7, 2013

(54) IMAGE PROCESSING DEVICE, AND IMAGE PROCESSING METHOD

(71) Applicant: Kenji Kondo, Tokyo (JP)

(72) Inventor: Kenji Kondo, Tokyo (JP)

(73) Assignee: SONY CORPORATION, Tokyo (JP)

(21) Appl. No.: 13/824,841

(22) PCT Filed: Nov. 9, 2011
(86) PCT No.: PCT/JP11/75859

§ 371 Date: Mar. 18, 2013

(30) Foreign Application Priority Data
Nov. 10, 2010 (JP) 2010-251965

(51) Int. Cl. G06T 5/00

(52) U.S. Cl. CPC G06T 5/001
USPC 382/238

(57) ABSTRACT

When a motion prediction/compensation unit 32 generates predicted image data by performing motion compensation using reference image data based on a motion vector detected through motion detection, a compensation control unit 3231 switches a filter coefficient supplied from a coefficient table 3232 to a filter unit 3233 according to a loop filter process on the reference image data used to generate the predicted image data. For example, when the loop filter process is not performed, a filter process is performed on the reference image data with filter characteristics in which noise removal strength is high. Therefore, since the predicted image data with small noise can be generated, and deterioration in the quality of a predicted image is reduced, and thus deterioration in compression efficiency can be suppressed.

### TECHNICAL FIELD

The present technology relates to an image processing device and an image processing method, and more particularly, to a technology for reducing deterioration in quality of a predicted image and suppressing deterioration in compression efficiency.

### BACKGROUND ART

In recent years, devices that treat image information as digital information and transmit and store high-efficient information at that time, for example, devices that conform with a scheme such as MPEG for performing compression by orthogonal transform such as discrete cosine transform and motion compensation have been proliferated in general households and broadcast stations.

In particular, MPEG2 (ISO/IEC 13818-2) is defined as a general image encoding scheme, and thus has currently been in wide use in a wide range of applications for professional use and consumer use. When the MPEG2 compression scheme is used, a high compression rate and good image quality can be realized by assigning a code rate (a bit rate) of 4 to 8 Mbps, for example, in a case of an interface scanned image with a standard resolution of 720×480 pixels. Further, in a case of an interface scanned image with the high resolution of 1920×1088 pixels, a high compression rate and good image quality can be realized by assigning a code rate of 18 to 22 Mbps.

A considerable amount of calculation is required in encoding and decoding than in a conventional encoding scheme such as MPEG2 or MPEG4. However, standardization for realizing higher encoding efficiency has been carried out as Joint Model of Enhanced-Compression Video Coding, and thus an international standard has been created in the name of H.264 and MPEG-4 Part 10 (hereinafter, referred to as H.264/AVC (Advanced Video Coding)).

In H.264/AVC, as illustrated in FIG. 1, one macro block constituted by 16×16 pixels can be divided as one of the pixel areas of 16×16, 16×8, 8×16, and 8×8, and each pixel area has each independent motion vector. Further, as illustrated in FIG. 1, the 8×8 pixel area can be divided as one of the sub-areas of 8×8 pixels, 8×4 pixels, 4×8 pixels, and 4×4 pixels, and each sub-area can have each independent motion vector. According to MPEG-2, a motion prediction and compensation process is performed in a motion prediction and compensation process unit of 16×16 pixels in a case of a frame motion compensation mode and in a motion prediction and compensation process unit of 16×8 pixels for each of the first and second fields in a case of a field motion compensation mode.

In H.264/AVC, as disclosed in Patent Document 1, a motion prediction and compensation process is performed with decimal pixel accuracy such as ¼ pixel accuracy. FIG. 2 is a diagram illustrating the motion prediction and compensation process with the ¼ pixel accuracy. In FIG. 2, a position “A” indicates the position of an integer accuracy pixel stored in a frame memory, positions “b,” “c,” and “d” are positions of ½ pixel accuracy, positions “e1,” “e2,” and “e3” are positions of ¼ pixel accuracy.

Clip1( ) is defined below, as in Expression (1).

$$\begin{matrix}[ Expression 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

In Expression (1), when an input image has 8-bit accuracy, the value of max_pix is 255.

Pixel values at the positions “b” and “d” are generated using a 6-tap FIR filter, as in Expression (2) and Expression (3).

F=A₋₂−5·A₋₁+20·A₀+20·A₁−5·A₂+A₃ (2)

b,d=Clip1((F+16)>>5) (3)

A pixel value at the position “c” is generated using a 6-tap FIR filter, as in Expression (6) and one of Expression (4) and Expression (5).

F=b₋₂−5·b₋₁+20·b₀+20·b₁−5·b₂+b₃ (4)

F=d₋₂−5·d₋₁+20·d₀+20·d₁−5·d₂+d₃ (5)

c=Clip1((F+512)>>10) (6)

Further, a Clip1 process is performed only once, after both product sum processes in horizontal and vertical directions are performed.

Pixel values at the positions “e1” to “e3” are generated by linear interpolation, as in Expression (7) to Expression (9).

e1=(A+b+1)>>1 (7)

e2=(b+d+1)>>1 (8)

e3=(b+c+1)>>1 (9)

In an image compression technology, standardization of HEVC (High Efficiency Video Coding) for realizing higher encoding efficiency than the H.264/AVC scheme has been examined. HEVC is an encoding scheme of which standardization is in progress by a joint standardization organization of ITU-T and ISO/IEC, JCTVC (Joint Collaboration Team-Video Coding). In HEVC, a basic unit called a coding unit (CU) extended from the concept of a macro block is defined. Non-Patent Document 1 suggests a technology for enabling image compression with a block size extended more than the macro block of 16×16 pixels. Further, in HEVC, a prediction unit (PU) which is a basic unit for division of a coding unit and prediction is also defined.

In HEVC, as disclosed in Non-Patent Document 2, a PQAO (Picture Quality Adaptive Offset) is considered to be provided between a deblock filter and adaptive loop filter. The kinds of offset, there are two kinds of offset called band offset and there are six kinds of offset called edge offset. Further, the offset may not be adapted. Encoding efficiency is improved by partitioning an image in a quad-tree and selectively performing encoding in each area according to one of the above-described kinds of offset.

### CITATION LIST

### Patent Document

Patent Document 1: Japanese Patent Application Laid-Open No. 2010-016453

### Non-Patent Document

Non-patent Document 1: “Video Coding Using Extended Block Sizes” (Study Group 16, Contribution 123, ITU, COM16-C123-E in January, 2009)
Non-patent Document 2: “CE8 Subtest 3: Picture Quality Adaptive Offset,” JCTVC-D122, in January 2011)

### SUMMARY OF THE INVENTION

### Problems to be Solved by the Invention

When predicted image data is generated by performing motion compensation using reference image data based on a motion vector detected through motion prediction and noise is contained in reference image data, the predicted image data also contains noise, thereby resulting in deterioration in compression efficiency.

Accordingly, an object of the present technology is to provide an image processing device and an image processing method capable of suppressing deterioration in compression efficiency by reducing deterioration in quality of a predicted image.

### Solutions to Problems

A first aspect of the present technology lies in an image processing device including: a loop filter unit that executes a filter process on reference image data referred to by a current block; an interpolation filter unit that generates predicted image data using the reference image data and a motion vector corresponding to the current block; and a filter control unit that switches a filter coefficient of an interpolation filter according to the filter process performed by the loop filter unit on the reference image data used by the interpolation filter.

According to the technology, for example, in an image processing device, such as an image encoding device that encodes a difference between input image data and predicted image data by dividing the input image data into a plurality of pixel blocks and performing a prediction process on each pixel block using reference image data or an image decoding device that performs a decoding process on compression image information generated by the image encoding device, a loop filter unit performs a filter process on the reference image data referred to by a current block, for example, a deblocking filter process or an adaptive loop filter process. An interpolation filter unit generates predicted image data using the reference image data and a motion vector corresponding to the current block. According to the filter process performed by the loop filter unit on the reference image data used by the interpolation filter, for example, noise removal strength is adjusted by switching the filter coefficient of the interpolation filter unit depending on whether the reference image data used by the interpolation filter unit is subjected to the filter process by the loop filter unit. The filter coefficient not subjected to the filter process by the loop filter unit is set to a coefficient in which the noise removal strength is enhanced more than that of the filter coefficient subjected to the filter process. When an offset process is adaptively performed and when the offset process is not performed, a coefficient in which the noise removal strength is enhanced more than a case when the offset process is performed is set.

A second aspect of the present technology lies in an image processing method including the steps of: executing a filter process on reference image data referred to by a current block; generating predicted image data using the reference image data and a motion vector corresponding to the current block; and switching a filter coefficient of the generating of the predicted image data according to the filter process in the executing of the filter process on the reference image data used in the generating of the predicted image data.

### Effects of the Invention

According to the technology, the loop filter unit performs the filter process on the reference image data referred to by the current block. The interpolation filter unit generates the predicted image data using the reference image data and the motion vector corresponding to the current block. The filter coefficient of the interpolation filter is switched according to the filter process performed on the reference image data used in the interpolation filter by the loop filter unit. Therefore, when the loop filter unit does not perform the filter process, the predicted image data with small noise can be generated, for example, by causing the interpolation filter unit to perform the filter process on the reference image data with the filter characteristics in which the noise removal strength is enhanced. Therefore, deterioration in the quality of a predicted image is reduced, and thus deterioration in compression efficiency can be suppressed.

### BRIEF DESCRIPTION OF DRAWINGS

FIG. 1 is a diagram illustrating block sizes in H.264/AVC.

FIG. 2 is a diagram illustrating a motion prediction and compensation process of ¼ pixel accuracy.

FIG. 3 is a diagram illustrating the configuration of an image encoding device.

FIG. 4 is a diagram illustrating the configuration a motion prediction/compensation unit.

FIG. 5 is a diagram illustrating an example of filter characteristics.

FIG. 6 is a diagram illustrating a hierarchical structure when the size of a macro block is extended.

FIG. 7 is a flowchart illustrating a process of an image encoding device.

FIG. 8 is a flowchart illustrating prediction processes.

FIG. 9 is a flowchart illustrating an intra-prediction process.

FIG. 10 is a flowchart illustrating an inter-prediction process.

FIG. 11 is a flowchart illustrating a motion compensation process.

FIG. 12 is a diagram illustrating a case in which ON/OFF of an adaptive loop filter process is switched between in units of frames.

FIG. 13 is a diagram illustrating the configuration of an image decoding device.

FIG. 14 is a diagram illustrating the configuration of a motion compensation unit.

FIG. 15 is a flowchart illustrating a process of the image decoding device.

FIG. 16 is a flowchart illustrating prediction processes.

FIG. 17 is a flowchart illustrating an inter-prediction process.

FIG. 18 is a diagram illustrating another configuration of the image encoding device.

FIG. 19 is a diagram illustrating a quad-tree structure.

FIG. 20 is a diagram illustrating band offset.

FIG. 21 is a diagram illustrating edge offset.

FIG. 22 is a diagram illustrating rule lists of the edge offset.

FIG. 23 is a flowchart illustrating a motion compensation process.

FIG. 24 is a diagram illustrating another configuration of the image decoding device.

FIG. 25 is a diagram illustrating an example of the overall configuration of a computer apparatus.

FIG. 26 is a diagram illustrating an example of the overall configuration of a television apparatus.

FIG. 27 is a diagram illustrating an example of the overall configuration of a portable telephone.

FIG. 28 is a diagram illustrating an example of the overall configuration of a recording/reproduction apparatus.

FIG. 29 is a diagram illustrating an example of the overall configuration of an imaging apparatus.

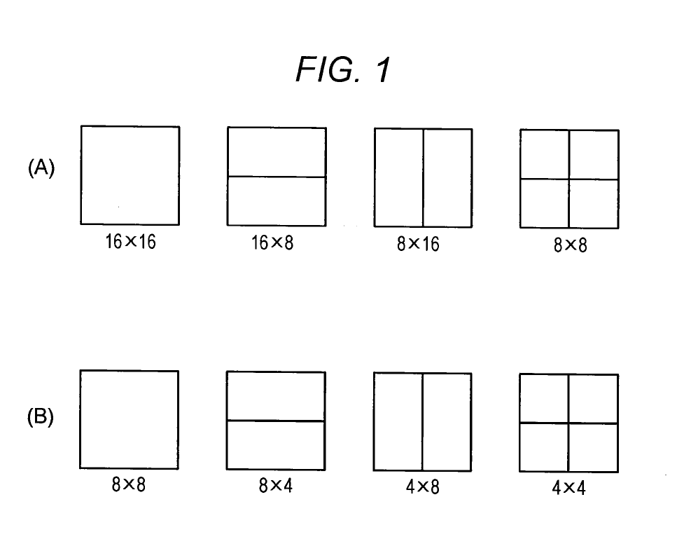

### MODE FOR CARRYING OUT THE INVENTION

Hereinafter, a mode for carrying out the present technology will be described. The description will be made in the following order.

1. Configuration of Image Encoding Device

2. Process of Image Encoding Device

3. Configuration of Image Decoding Device

4. Process of Image Decoding Device

5. Another Configuration and Process of Image Encoding Device

6. Another Configuration and Process of Image Decoding Device

7. Case of Software Process

8. Case of Application to Electronic Apparatus

### <1. Configuration of Image Encoding Device>

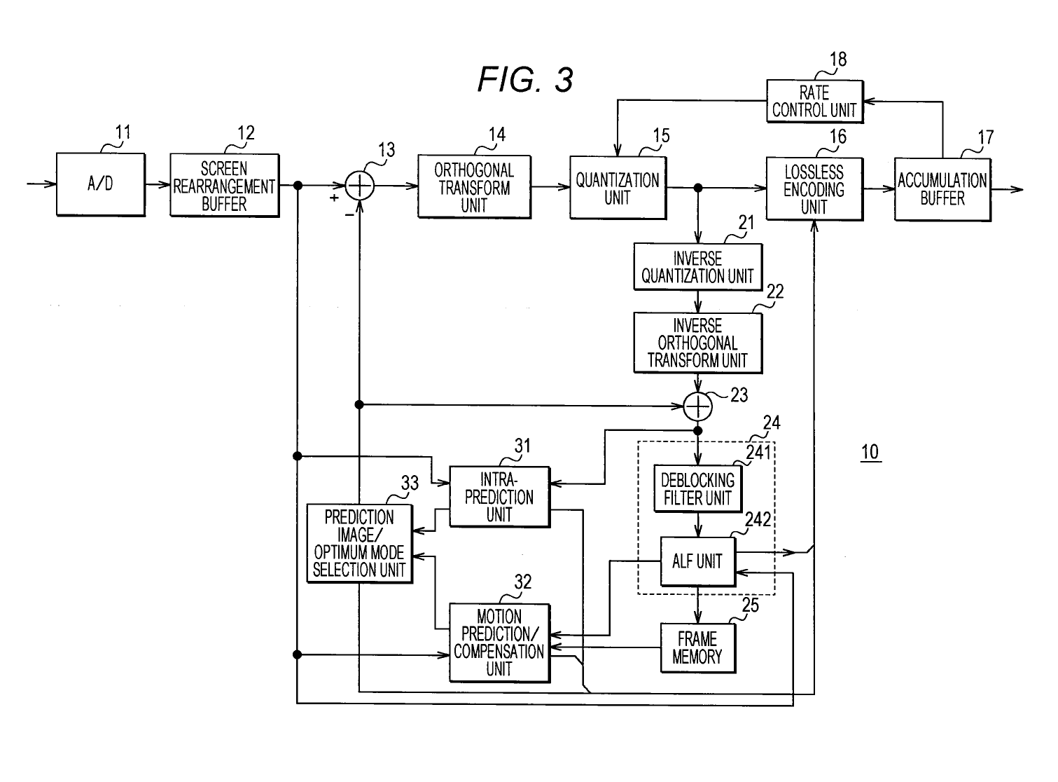

FIG. 3 is a diagram illustrating the configuration of an image encoding device to which an image processing device is applied. An image encoding device 10 includes an analog/digital conversion unit (A/D conversion unit) 11, a screen rearrangement buffer 12, a subtraction unit 13, an orthogonal transform unit 14, a quantization unit 15, a lossless encoding unit 16, an accumulation buffer 17, and a rate control unit 18. The image encoding device 10 further includes an inverse quantization unit 21, an inverse orthogonal transform unit 22, an addition unit 23, a loop filter unit 24, a frame memory 25, an intra-prediction unit 31, a motion prediction/compensation unit 32, and a predicted image/optimum mode selection unit 33. Further, the loop filter unit 24 includes, for example, a deblocking filter unit 241 and an ALF (Adaptive Loop Filter) unit 242.

The A/D conversion unit 11 converts an analog image signal into digital image data and outputs the digital image data to the screen rearrangement buffer 12.

The screen rearrangement buffer 12 sorts frames of the image data output from the A/D conversion unit 11. The screen rearrangement buffer 12 sorts the frames according to a GOP (Group of Pictures) structure relevant to an encoding process and outputs the image data obtained after the sorting to the subtraction unit 13, the ALF unit 242, the intra-prediction unit 31, and the motion prediction/compensation unit 32.

The subtraction unit 13 is supplied with the image data output from the screen rearrangement buffer 12 and predicted image data selected by the predicted image/optimum mode selection unit 33 to be described below. The subtraction unit 13 calculates prediction error data which is a difference between the image data output from the screen rearrangement buffer 12 and the predicted image data supplied from the predicted image/optimum mode selection unit 33, and then outputs the prediction error data to the orthogonal transform unit 14.

The orthogonal transform unit 14 performs an orthogonal transform process such as discrete cosine transform (DCT) or Karhunen-Loeve transform on the prediction error data output from the subtraction unit 13. The orthogonal transform unit 14 outputs transform coefficient data obtained through the orthogonal transform process to the quantization unit 15.

The quantization unit 15 is supplied with the transform coefficient data output from the orthogonal transform unit 14 and a rate control signal output from the rate control unit 18 to be described below. The quantization unit 15 performs quantization on the transform coefficient data and outputs quantization data to the lossless encoding unit 16 and the inverse quantization unit 21. The quantization unit 15 switches a quantization parameter (quantization scale) based on the rate control signal from the rate control unit 18 and changes the bit rate of the quantization data.

The lossless encoding unit 16 is supplied with the quantization data output from the quantization unit 15, prediction mode information from the intra-prediction unit 31 to be described below or prediction mode information, a differential motion vector, and loop filter information, and the like from the motion prediction/compensation unit 32. Further, information indicating whether an optimum mode is used for the intra-prediction or the inter-prediction is supplied from the predicted image/optimum mode selection unit 33. The prediction mode information includes a prediction mode, block size information on a motion prediction unit, or the like according to the intra-prediction or inter-prediction. The lossless encoding unit 16 performs a lossless encoding process on the quantization data through, for example, variable-length coding or arithmetic coding to generate image compression information and outputs the image compression information to the accumulation buffer 17. The lossless encoding unit 16 performs the lossless encoding process on the prediction mode information supplied from the intra-prediction unit 31, when the optimum mode is the intra-prediction. The lossless encoding unit 16 performs lossless encoding on the prediction mode information, the differential motion vector, or the like supplied from the motion prediction/compensation unit 32, when the optimum mode is the inter-prediction. The lossless encoding unit 16 causes information obtained through the lossless encoding to be included in the image compression information. For example, the lossless encoding unit 16 adds the information to header information of an encoding stream which is the image compression information. The lossless encoding unit 16 causes the loop filter information or loop filter information subjected to the lossless encoding to be included in the image compression information.

The accumulation buffer 17 accumulates the image compression information from the lossless encoding unit 16. The accumulation buffer 17 outputs the accumulated image compression information at a transmission rate suitable for a transmission path.

The rate control unit 18 monitors a free space of the accumulation buffer 17, generates a rate control signal according to the free space, and outputs the rate control signal to the quantization unit 15. For example, the rate control unit 18 acquires information indicating the free space from the accumulation buffer 17. When the free space is small, the rate control unit 18 reduces the bit rate of the quantization data according to the rate control signal. Further, when the free space of the accumulation buffer 17 is sufficiently large, the rate control unit 18 increases the bit rate of the quantization data by the rate control signal.

The inverse quantization unit 21 performs an inverse quantization process on the quantization data supplied from the quantization unit 15. The inverse quantization unit 21 outputs the transform coefficient data obtained through the inverse quantization process to the inverse orthogonal transform unit 22.

The inverse orthogonal transform unit 22 performs an inverse orthogonal transform process on the transform coefficient data supplied from the inverse quantization unit 21 and outputs obtained data to the addition unit 23.

The addition unit 23 generates decoded image data by adding the data supplied from the inverse orthogonal transform unit 22 to the predicted image data supplied from the predicted image/optimum mode selection unit 33, and then outputs the decoded image data to the deblocking filter unit 241 and the intra-prediction unit 31. The decoded image data is used as image data of a reference image.

The loop filter unit 24 is a filter that is embedded in an encoding loop and performs subsequent prediction using the decoded image data as the reference image data. The loop filter unit 24 excludes the influence of noise from a prediction error in the motion compensation prediction by generating the reference image data from which the noise is removed, and thus improves encoding efficiency.

The deblocking filter unit 241 of the loop filter unit 24 performs a filter process of reducing block distortion occurring when an image is encoded. The deblocking filter unit 241 performs a deblocking filter process of removing block distortion from the decoded image data supplied from the addition unit 23 and outputs the processed decoded image data to the ALF unit 242. The deblocking filter unit 241 adaptively performs the deblocking filter process so that the deblocking filter process may not be performed in a partial area in a frame.

The ALF unit 242 performs a filter process of removing distortion which has not be removed in the filter process of the deblocking filter unit 241 or noise of an area not subjected to the filter process by the deblocking filter unit 241. The ALF unit 242 performs an adaptive loop filter process only on an area in which the encoding efficiency is improved when the filter process is performed to reduce an error between the input image data supplied from the screen rearrangement buffer 12 and the decoded image data supplied from the deblocking filter unit 241. The ALF unit 242 outputs the processed decoded image data to the frame memory 25. The ALF unit 242 outputs filter information on the adaptive loop filter process to the lossless encoding unit 16 so as to be included in the image compression information, so that the same adaptive loop filter process as the image encoding process can be performed in an image decoding process. As the filter information, for example, ALF flag information and a filter coefficient or the like used in the adaptive loop filter process are used. The ALF unit 242 outputs the ALF flag information to the motion prediction/compensation unit 32.

As the ALF flag information, for example, adaptive_loop_filter_flag, alf_cu_control_flag, alf_flag, or the like is used. Here, adaptive_loop_filter_flag is a flag indicating whether the adaptive loop filter process is performed in the current slice. Further, alf_cu_control_flag is a flag indicating whether the adaptive loop filter process is performed on luminance data. Furthermore, alf_flag is a flag identifying a coding unit performing the adaptive loop filter process. Accordingly, an area in which the adaptive loop filter process is performed on the reference image data can be determined based on the ALF flag information.

The frame memory 25 retains the decoded image data subjected to the filter process and supplied from the ALF unit 242. The decoded image data retained in the frame memory 25 is supplied as the reference image data to the motion prediction/compensation unit 32.

The intra-prediction unit 31 determines an optimum intra-prediction mode by performing prediction in all of the intra-prediction mode candidates using the input image data of an encoding target image supplied from the screen rearrangement buffer 12 and the reference image data supplied from the addition unit 23. For example, the intra-prediction unit 31 calculates a cost function value in each intra-prediction mode and sets, as the optimum intra-prediction mode, the intra-prediction mode in which the encoding efficiency is the best based on the calculated cost function value. The intra-prediction unit 31 outputs the predicted image data generated in the optimum intra-prediction mode and the cost function value in the optimum intra-prediction mode to the predicted image and optimum mode selection unit 33. The intra-prediction unit 31 outputs prediction mode information indicating the optimum intra-prediction mode to the lossless encoding unit 16.

The motion prediction/compensation unit 32 determines an optimum inter-prediction mode by performing prediction in all of the inter-prediction mode candidates using the input image data of an encoding target image supplied from the screen rearrangement buffer 12 and the reference image data supplied from the frame memory 25. For example, the motion prediction/compensation unit 32 calculates a cost function value in each inter-prediction mode and sets, as the optimum inter-prediction mode, the inter-prediction mode in which the encoding efficiency is the best based on the calculated cost function value. The motion prediction/compensation unit 32 outputs the predicted image data generated in the optimum inter-prediction mode and the cost function value in the optimum inter-prediction mode to the predicted image and optimum mode selection unit 33. The motion prediction/compensation unit 32 outputs prediction mode information on the optimum inter-prediction mode to the lossless encoding unit 16. The motion prediction/compensation unit 32 switches a filter coefficient according to the filter process performed on the reference image data by the loop filter unit 24 in order to suppress deterioration in the encoding efficiency caused due to noise of the reference image data.

Hereinafter, a case will be described in which the filter coefficient when the adaptive loop filter process is not performed is switched to a coefficient for which noise removal strength is enhanced, compared to the filter coefficient when the adaptive loop filter process is performed.

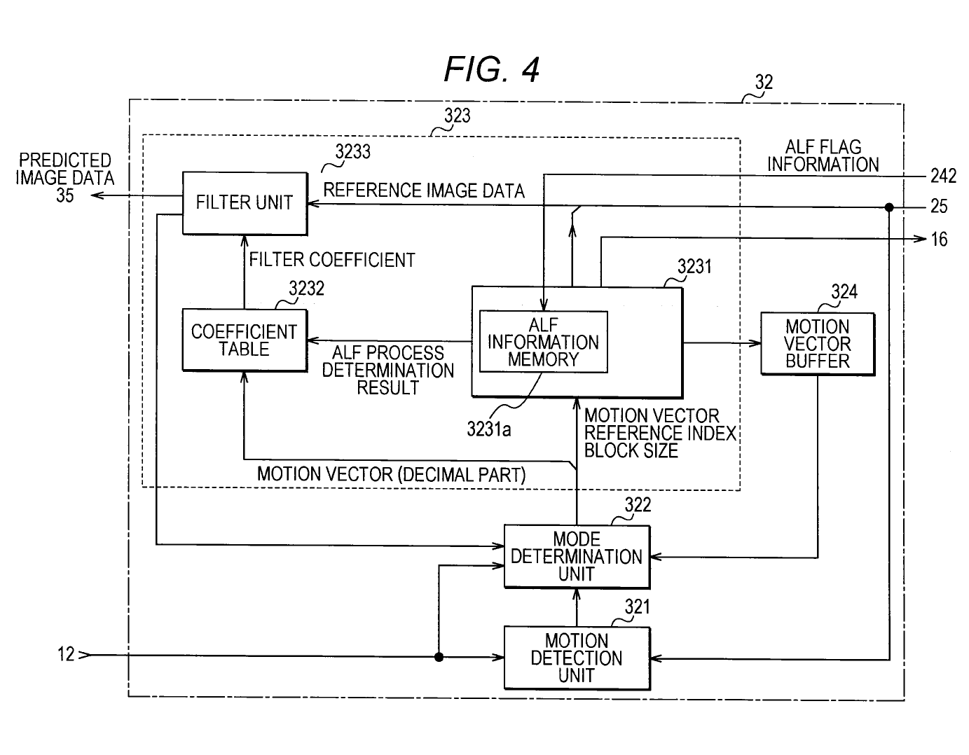

FIG. 4 is a diagram illustrating the configuration of the motion prediction/compensation unit 32. The motion prediction/compensation unit 32 includes a motion detection unit 321, a mode determination unit 322, a motion compensation processing unit 323, and a motion vector buffer 324.

The motion detection unit 321 is supplied with the sorted input image data supplied from the screen rearrangement buffer 12 and the reference image data read from the frame memory 25. The motion detection unit 321 detects a motion vector by performing motion search in all of the inter-prediction mode candidates. The motion detection unit 321 outputs, to the mode determination unit 322, a motion vector indicating the detected motion vector together with the input image data and the reference image data at the time of detecting the motion vector.

The mode determination unit 322 is supplied with the motion vector and the input image data from the motion detection unit 321, the predicted image data from the motion compensation processing unit 323, and a motion vector of an adjacent prediction unit from the motion vector buffer 324. The mode determination unit 322 sets a prediction motion vector by performing median prediction or the like using the motion vector of the adjacent prediction unit and calculates a differential motion vector indicating a difference between the prediction motion vector and the motion vector detected by the motion detection unit 321. The mode determination unit 322 calculates the cost function values in all of the inter-prediction mode candidates using the input image data, the predicted image data, and the differential motion vector. The mode determination unit 322 determines a mode in which the calculated cost function value is the minimum as the optimum inter-prediction mode. The mode determination unit 322 outputs, to the motion compensation processing unit 323, prediction mode information indicating the determined optimum inter-prediction mode and the cost function value together with the motion vector relevant to the optimum inter-prediction mode, the differential motion vector, and the like. The mode determination unit 322 outputs the prediction mode information relevant to the inter-prediction mode and the motion vector to the motion compensation processing unit 323 in order to calculate the cost function values in all of the inter-prediction mode candidates.

For example, the cost function values are calculated based on one method of a High Complexity mode or a Low Complexity mode so as to be determined in JM (Joint Model) which is reference software in the H.264/AVC scheme.

That is, in the High Complexity mode, a tentatively lossless encoding process is performed in all of the prediction mode candidates to calculate the cost function value expressed by Expression (10) below for each prediction mode.

Cost(ModeεΩ)=D+λ·R (10)

Ω indicates the whole set of the prediction mode candidates in which the image of the prediction unit is encoded. D indicates a differential energy (distortion) between the predicted image and the input image when the encoding is performed in the prediction mode. R indicates an amount of occurring code including an orthogonal transform coefficient, the prediction mode information, or the like, λ indicates the Lagrange multiplier given as a function of a quantization parameter QP.

That is, in order to perform the encoding in the High Complexity mode, a tentative encoding process is required to be performed once in all of the prediction mode candidates to calculate the parameters D and R, and thus a larger amount of calculation is necessary.

In the Low Complexity mode, on the other hand, the predicted image is generated and header bits including the differential motion vector, the prediction mode information, or the like are generated in all of the prediction mode candidates to calculate the cost function values expressed by Expression (11) below.

Cost(ModeεΩ)=D+QP2Quant(QP)·Header Bit (11)

Ω indicates the whole set of the prediction mode candidates in which the image of the prediction unit is encoded. D indicates a differential energy (distortion) between the predicted image and the input image when the encoding is performed in the prediction mode. Header Bit is the header bits for the prediction mode and QP2Quant is a function given as a function of the quantization parameter QP.

That is, in the Low Complexity mode, the prediction process is required to be performed on each prediction mode, but even a decoded image is not necessary. Therefore, the encoding can be realized with the lower amount of calculation than the amount of calculation in the High Complexity mode.

The motion compensation processing unit 323 includes a compensation control unit 3231, a coefficient table 3232, and a filter unit 3233. The motion compensation processing unit 323 determines whether the reference image data is subjected to the adaptive loop filter process based on the ALF flag information generated by the ALF unit 242. The motion compensation processing unit 323 switches filter characteristics in the filter process on the reference image data used to generate the predicted image data according to the determination result (hereinafter, referred to as an “ALF process determination result”). For example, the motion compensation processing unit 323 switches the filter characteristics in the filter process by switching a filter coefficient supplied from the coefficient table 3232 to the filter unit 3233. In FIG. 4, the filter coefficient is configured to be supplied from the coefficient table 3232 to the filter unit 3233. However, the filter coefficient may be configured to be supplied from the compensation control unit 3231 to the filter unit 3233.

The compensation control unit 3231 includes an ALF information memory 3231a that stores the ALF flag information supplied from the ALF unit 242. The compensation control unit 3231 controls reading the reference image data from the frame memory 26 based on the block size (including a shape) of the prediction unit supplied from the mode determination unit 322, the motion vector, and a reference index. The compensation control unit 3231 determines whether the read reference image data is subjected to the adaptive loop filter process based on the ALF flag information stored in the ALF information memory 3231a and outputs an ALF process determination result to the coefficient table 3232. For example, when the compensation control unit 3231 determines that the reference image data is subjected to the adaptive loop filter process based on the ALF flag information, the compensation control unit 3231 sets alf_applied_flag as the ALF process determination result to be true. Conversely, when the compensation control unit 3231 determines that the reference image data is not subjected to the adaptive loop filter process, the compensation control unit 3231 sets alf_applied_flag to be false. The compensation control unit 3231 outputs alf_applied_flag indicating the ALF process determination result to the coefficient table 3232.

The coefficient table 3232 is supplied with a decimal part of the motion vector and the ALF process determination result generated by the compensation control unit 3231. The coefficient table 3232 has a filter coefficient (filter_coef_without_ALF) used for the reference image data not subjected to the adaptive loop filter process and a filter coefficient (filter_coef_with_ALF) used for the reference image data subjected to the adaptive loop filter process.

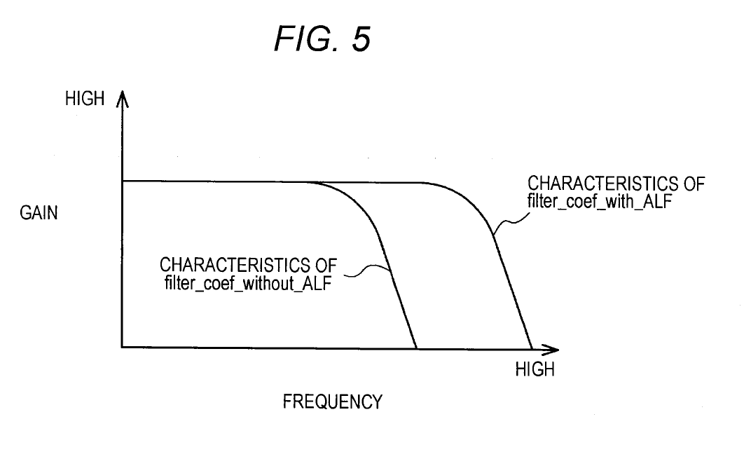

When the reference image data is not subjected to the adaptive loop filter process, noise of the reference image data is not removed. Accordingly, filter_coef_without_ALF is set as a coefficient with filter characteristics in which a noise removal strength is greater than that of the filter coefficient used for the reference image data subjected to the adaptive loop filter process. Conversely, when the reference image data is subjected to the adaptive loop filter process, the noise is expected to be removed. Accordingly, filter_coef_with_ALF is set as a coefficient with filter characteristics preserving components from a low-frequency component to a high-frequency component. FIG. 5 is a diagram illustrating an example of the filter characteristics. The characteristics obtained using filter_coef_without_ALF are configured as low-frequency pass filter characteristics in which attenuation of the high-frequency is large, compared to the characteristics obtained using filter_coef_with_ALF. Further, when the reference image data is not subjected to the adaptive loop filter process, the filter characteristics may be filter characteristics in which the noise removal strength is increased, compared to the case in which the reference image data is subjected to the adaptive loop filter process, and are not limited to the characteristics illustrated in FIG. 5. For example, the filter characteristics may be attenuation characteristics different from the characteristics illustrated in FIG. 5.

Even when the motion vector has decimal pixel accuracy, the coefficient table 3232 stores a plurality of filter coefficients corresponding to decimal pixel positions so that the predicted image data with the decimal image accuracy can be generated through an interpolation filter process, as described above. That is, the coefficient table 3232 stores a filter coefficient set (filter_coef_set_wo_ALF) used for the reference image data not subjected to the adaptive loop filter process and a filter coefficient set (filter_coef_set_w_ALF) used for the reference image data subjected to the adaptive loop filter process.

The coefficient table 3232 outputs the decimal part of the motion vector and the filter coefficient selected according to the ALF process determination result to the filter unit 3233. For example, when alf_applied_flag is true, the coefficient table 3232 selects the filter coefficient according to the decimal part of the motion vector from filter_coef_set_w_ALF and outputs the filter coefficient to the filter unit 3233. Further, when alf_applied_flag is false, the coefficient table 3232 selects the filter coefficient according to the decimal part of the motion vector from the filter_coef_set_wo_ALF and outputs the filter coefficient to the filter unit 3233.

The filter unit 3233 performs an interpolation filter process of obtaining given predicted image data with the decimal pixel accuracy in the reference image data of a current block by using the filter coefficient supplied from the coefficient table 3232. When the reference image data is not subjected to the adaptive loop filter process, the filter unit 3233 performs the filter process with the filter characteristics in which the noise removal strength is enhanced, compared to the filter coefficient used for the reference image data subjected to the adaptive loop filter process. When the mode determination unit 322 calculates the cost function value, the filter unit 3233 outputs the generated predicted image data to the mode determination unit 322 so that the optimum inter-prediction mode can be determined. The filter unit 3233 outputs the predicted image data generated in the optimum inter-prediction mode to the predicted image and optimum mode selection unit 33.

Although not illustrated, the motion compensation processing unit 323 outputs the motion vector used for motion compensation to the motion vector buffer 324 and outputs the prediction mode information of the optimum inter-prediction and the differential motion vector or the like in the corresponding mode to the lossless encoding unit 16. The motion compensation processing unit 323 outputs the cost function value in the optimum inter-prediction to the predicted image and optimum mode selection unit 33 illustrated in FIG. 3.

The predicted image and optimum mode selection unit 33 compares the cost function value supplied from the intra-prediction unit 31 to the cost function value supplied from the motion prediction/compensation unit 32 and selects the mode with the smaller cost function value as the optimum mode in which the encoding efficiency is the best. The predicted image and optimum mode selection unit 33 outputs the predicted image data generated in the optimum mode to the subtraction unit 13 and the addition unit 23. The predicted image and optimum mode selection unit 33 outputs information indicating whether the optimum mode is the intra-prediction mode or the inter-prediction mode to the lossless encoding unit 16. The predicted image and optimum mode selection unit 33 switches between the intra-prediction and the inter-prediction in units of slices.

### <2. Process of Image Encoding Device>

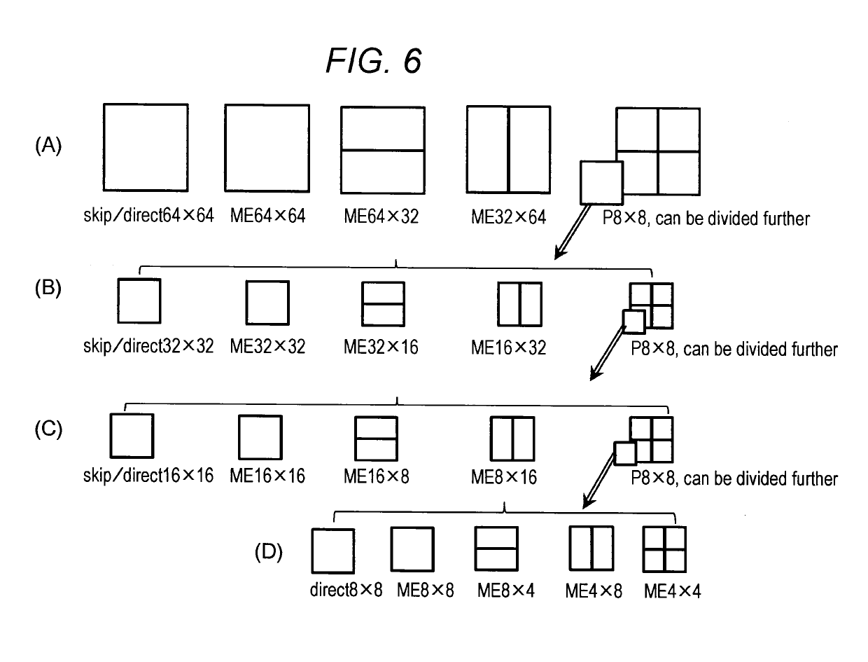

The image encoding device performs the encoding process by extending the size of the macro block more than, for example, the H.264/AVC scheme. FIG. 6 is a diagram illustrating an example of a hierarchical structure when the size of the macro block is extended. In FIG. 6, (C) and (D) of FIG. 6 illustrate cases in which coding units have the size of 16×16 pixels of the macro block and the size of 8×8 pixels of the sub-macro block defined in the H.264/AVC scheme. Further, (A) of FIG. 6 illustrates a case in which the block size of the coding unit is 64×64 pixels and (B) of FIG. 6 illustrates a case in which the block size of the coding unit is 32×32 pixels. In FIG. 6, “Skip/direct” indicates a block size when a skip micro-block and a direct mode are selected.

In one hierarchy, a plurality of prediction units including sizes with which the coding unit is divided are set. For example, in the hierarchy of the macro block of the 64×64 pixels illustrated in (A) of FIG. 6, sizes of 64×64 pixels, 64×32 pixels, 32×64 pixels, and 32×32 pixels are set with the block sizes of the prediction units in the same hierarchy. Although not illustrated, prediction units in which the coding unit is divided into two pieces with asymmetric block sizes may be provided. Further, “ME” indicates the block size of a prediction unit. Furthermore, “P8×8” indicates that a block size can be divided further to be smaller in a lower-level hierarchy.

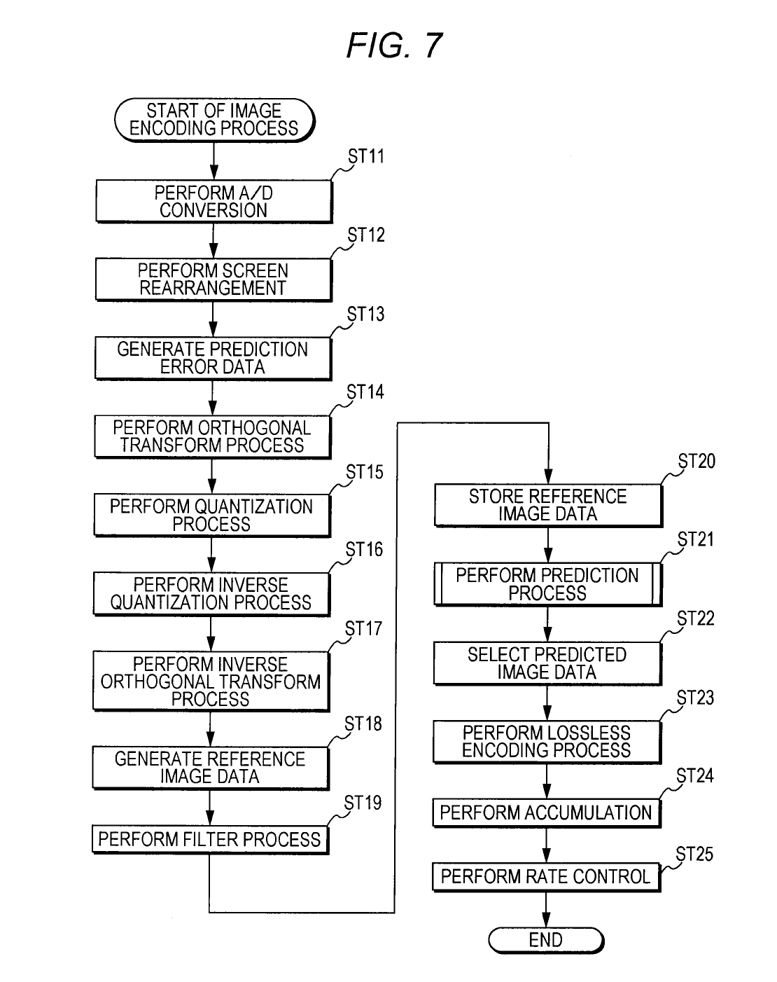

Next, a process of the image encoding device will be described with reference to the flowchart illustrated in FIG. 7. In step ST11, the A/D conversion unit 11 performs A/D conversion on an input image signal.

In step ST12, the screen rearrangement buffer 12 performs image sorting. The screen rearrangement buffer 12 stores the image data supplied from the A/D conversion unit 11 and performs sorting from a displaying order of respective pictures to an encoding order.

In step ST13, the subtraction unit 13 generates the prediction error data. The subtraction unit 13 generates the prediction error data by calculating a difference between the image data of the images sorted in step ST12 and the predicted image data selected by the predicted image and optimum mode selection unit 33. The prediction error data has a smaller amount of data than that of the original image data. Accordingly, the amount of data can be compressed, compared to a case in which an image is directly encoded.

In step ST14, the orthogonal transform unit 14 performs an orthogonal transform process. The orthogonal transform unit 14 performs the orthogonal transform on the prediction error data supplied from the subtraction unit 13. Specifically, the orthogonal transform unit 14 performs orthogonal transform such as discrete cosine transform or Karhunen-Loeve transform on the prediction error data and outputs the transform coefficient data.

In step ST15, the quantization unit 15 performs the quantization process. The quantization unit 15 quantizes the transform coefficient data. When the quantization process is performed, rate control is performed, as described in the process of step ST25 to be described below.

In step ST16, the inverse quantization unit 21 performs the inverse quantization process. The inverse quantization unit 21 performs the inverse quantization on the transform coefficient data quantized by the quantization unit 15 according to the characteristics corresponding to the characteristics of the quantization unit 15.

In step ST17, the inverse orthogonal transform unit 22 performs the inverse orthogonal transform process.

The inverse orthogonal transform unit 22 performs the inverse orthogonal transform on the transform coefficient data subjected to the inverse quantization by the inverse quantization unit 21 according to the characteristics corresponding to the characteristics of the orthogonal transform unit 14.

In step ST18, the addition unit 23 generates the reference image data. The addition unit 23 generates decoding data (reference image data) by adding the predicted image data supplied from the predicted image and optimum mode selection unit 33 to the data obtained after the inverse orthogonal transform at a position corresponding to the predicted image.

In step ST19, the deblocking filter unit 241 performs the filter process. The deblocking filter unit 241 removes block distortion by filtering the decoded image data output from the addition unit 23.

In step ST20, the frame memory 25 stores the reference image data. The frame memory 25 stores the decoding data (reference image data) obtained after the filter process.

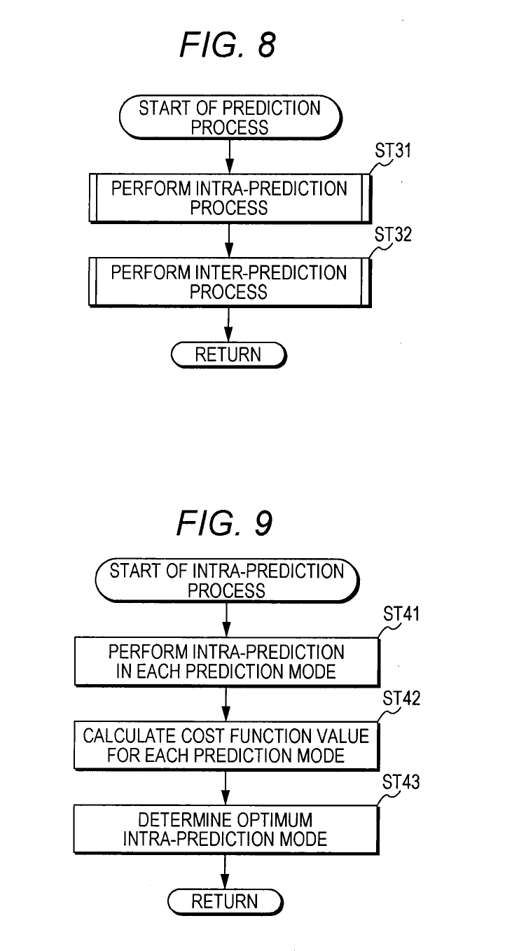

In step ST21, the intra-prediction unit 31 and the motion prediction/compensation unit 32 each perform the prediction process. That is, the intra-prediction unit 31 performs the intra-prediction process in the intra-prediction mode and the motion prediction/compensation unit 32 performs the motion prediction and compensation process in the inter-prediction mode. The prediction process will be described in detail below with reference to FIG. 8. Through these processes, the prediction process is each performed in all of the prediction mode candidates and the cost function values are calculated in all of the prediction mode candidates. The optimum intra-prediction mode and the optimum inter-prediction mode are selected based on the calculated cost function values, and then the predicted image generated in the selected prediction mode, its cost function, and the prediction mode information are supplied to the predicted image and optimum mode selection unit 33.

In step ST22, the predicted image and optimum mode selection unit 33 selects the predicted image data. The predicted image and optimum mode selection unit 33 determines the optimum mode in which the encoding efficiency is the best based on the respective cost function values output from the intra-prediction unit 31 and the motion prediction/compensation unit 32. That is, the predicted image and optimum mode selection unit 33 determines the coding unit in which the encoding efficiency is the best from, for example, the respective hierarchies illustrated in FIG. 6 and the shape of the prediction unit in the coding unit and determines whether to perform the intra-prediction and the inter-prediction. The predicted image and optimum mode selection unit 33 outputs the predicted image data of the determined optimum mode to the subtraction unit 13 and the addition unit 23. The predicted image data is used for the calculation of step ST13 and step ST18, as described above.

In step ST23, the lossless encoding unit 16 performs the lossless encoding process. The lossless encoding unit 16 performs the lossless encoding on the quantization data output from the quantization unit 15. That is, the lossless encoding such as variable-length coding or arithmetic coding is performed on the quantization data to compress the data. The lossless encoding unit 16 performs the lossless encoding on the prediction mode information corresponding to the predicted image data selected in step ST22, the differential motion vector generated through the inter-prediction, or the like, so that the lossless encoded data such as the prediction mode information can be included in the image compression information generated by performing the lossless encoding on the quantization data. The lossless encoding unit 16 causes the loop filter information or the loop filter information subjected to the lossless encoding to be included in the image compression information.

In step ST24, the accumulation buffer 17 performs an accumulation process. The accumulation buffer 17 accumulates the image compression information output from the lossless encoding unit 16. The image compression information accumulated in the accumulation buffer 17 is appropriately read and is transmitted to the decoding side via the transmission path.

In step ST25, the rate control unit 18 performs the rate control. When the accumulation buffer 17 accumulates the image compression information, the rate control unit 18 controls a rate of the quantization process performed by the quantization unit 15 so that overflow or underflow does not occur in the accumulation buffer 17.

Next, the prediction process in step ST21 of FIG. 7 will be described with reference to the flowchart of FIG. 8.

In step ST31, the intra-prediction unit 31 performs the intra-prediction process. The intra-prediction unit 31 performs the intra-prediction on an image of the prediction unit to be encoded in all of the intra-prediction mode candidates. The decoded image data before the blocking filter process is performed by the deblocking filter unit 241 is used as the image data of the decoded image referred to in the intra-prediction. Through the intra-prediction process, the intra-prediction is performed in all of the intra-prediction mode candidates to calculate the cost function values in all of the intra-prediction mode candidates. Then, based on the calculated cost function values, one intra-prediction mode in which the encoding efficiency is the best is selected from all of the intra-prediction modes.

In step ST32, the motion prediction/compensation unit 32 performs the inter-prediction process. The motion prediction/compensation unit 32 performs the inter-prediction process in the inter-prediction mode candidates using the decoded image data obtained after the deblocking process and stored in the frame memory 25. Through the inter-prediction process, the prediction process is performed in all of the inter-prediction mode candidates to calculate the cost function values in all of the inter-prediction mode candidates. Then, based on the calculated cost function values, one inter-prediction mode in which the encoding efficiency is the best is selected from all of the inter-prediction modes.

Next, the inter-prediction process of step ST31 in FIG. 8 will be described with reference to the flowchart of FIG. 9.

In step ST41, the intra-prediction unit 31 performs the intra-prediction in each prediction mode. The intra-prediction unit 31 generates the predicted image data in each intra-prediction mode using the decoded image data before the blocking filter process.

In step ST42, the intra-prediction unit 31 calculates the cost function value in each prediction mode. As described above, for example, the cost function values are calculated based on one method of a High Complexity mode or a Low Complexity mode so as to be determined in JM (Joint Model) which is reference software in the H.264/AVC scheme. That is, in the High Complexity mode, as the process of step ST42, the cost function value expressed by Expression (10) described above is calculated in each prediction mode by performing even a tentative lossless encoding process on all of the prediction mode candidates. Further, in the Low Complexity mode, as the process of step ST42, the cost function value expressed by Expression (11) described above is calculated in each prediction mode by generating the predicted image and calculating even the header bits of the motion vector, the prediction mode information, or the like for all of the prediction mode candidates.

In step ST43, the intra-prediction unit 31 determines the optimum intra-prediction mode. The intra-prediction unit 31 determines the optimum intra-prediction mode by selecting one intra-prediction mode in which the cost function value is the minimum from the cost function values based on the cost function values calculated in step ST42.

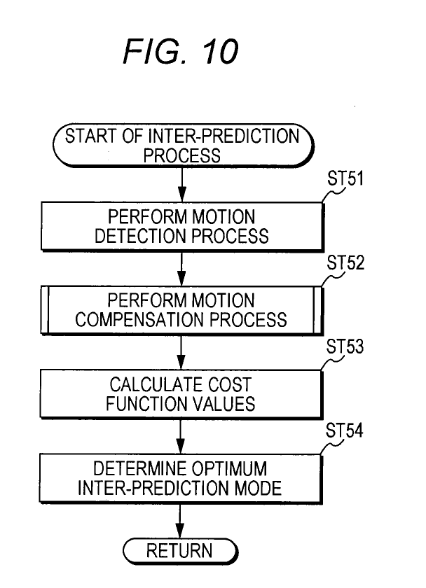

Next, the inter-prediction process of step ST32 in FIG. 8 will be described with reference to the flowchart of FIG. 10.

In step ST51, the motion prediction/compensation unit 32 performs the motion prediction process. The motion prediction/compensation unit 32 detects the motion vector by performing the motion prediction in each prediction mode, and then the process proceeds to step ST52.

In step ST52, the motion prediction/compensation unit 32 performs the motion compensation process. The motion prediction/compensation unit 32 generates the predicted image data by performing the motion compensation on the reference image data based on the motion vector detected in step ST51.

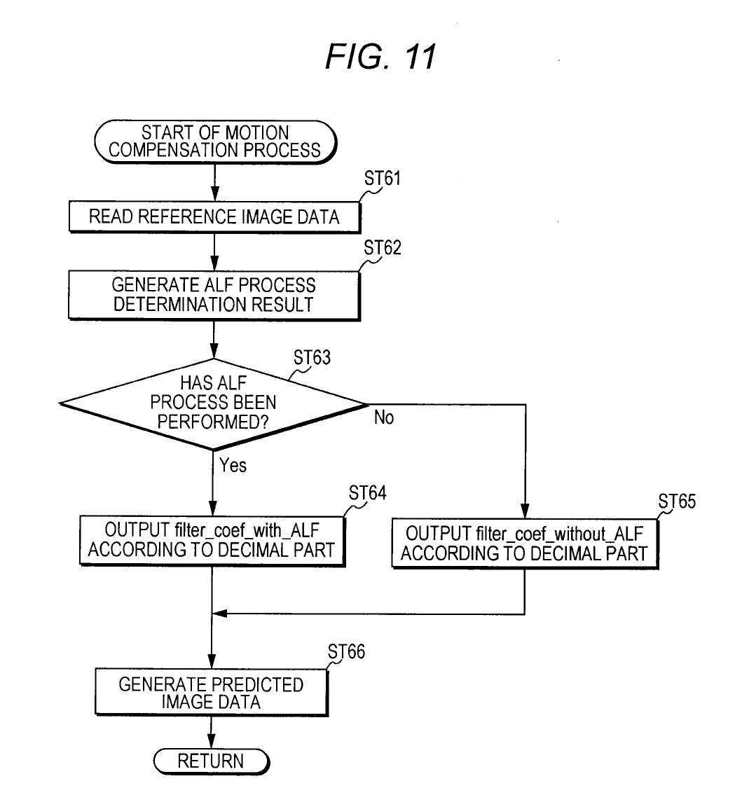

FIG. 11 is a flowchart illustrating the motion compensation process. In step ST61, the motion prediction/compensation unit 32 reads the reference image data. The compensation control unit 3231 of the motion prediction/compensation unit 32 determines a reading area based on the size of the prediction unit performing the motion compensation, the motion vector detected for the prediction unit performing the motion compensation, and the reference index indicating the reference image used to detect the motion vector. Further, the compensation control unit 3231 reads the image data of the determined reading area from the frame memory 25, and then the process proceeds to step ST62.

In step ST62, the motion prediction/compensation unit 32 generates the ALF process determination result. The compensation control unit 3231 of the motion prediction/compensation unit 32 generates the ALF process determination result by determining whether the reference image data is subjected to the adaptive loop filter process based on the flag information generated by the ALF unit 242, and then the process proceeds to step ST63.

In step ST63, the motion prediction/compensation unit 32 determines whether the adaptive loop filter process is performed. When the reference image data read in step ST61 is subjected to the adaptive loop filter process, the motion prediction/compensation unit 32 causes the process to proceed to step ST64. When the reference image data is not subjected to the adaptive loop filter process, the motion prediction/compensation unit 32 causes the process to proceed to step ST65.

In step ST64, the motion prediction/compensation unit 32 outputs filter_coef_with_ALF according to the decimal part of the motion vector. When the ALF process determination result indicates the application of the filter, the coefficient table 3232 of the motion prediction/compensation unit 32 selects filter_coef_with_ALF according to the decimal part of the motion vector from filter_coef_set_w_ALF and outputs filter_coef_with_ALF to the filter unit 3233. Then, the process proceeds to step ST.

In step ST65, the motion prediction/compensation unit 32 outputs filter_coef_with_ALF according to the decimal part of the motion vector. When the ALF process determination result does not indicate the application of the filter, the coefficient table 3232 of the motion prediction/compensation unit 32 selects filter_coef_without_ALF according to the decimal part of the motion vector from filter_coef_set_wo_ALF and outputs filter_coef_without_ALF to the filter unit 3233. Then, the process proceeds to step ST66.

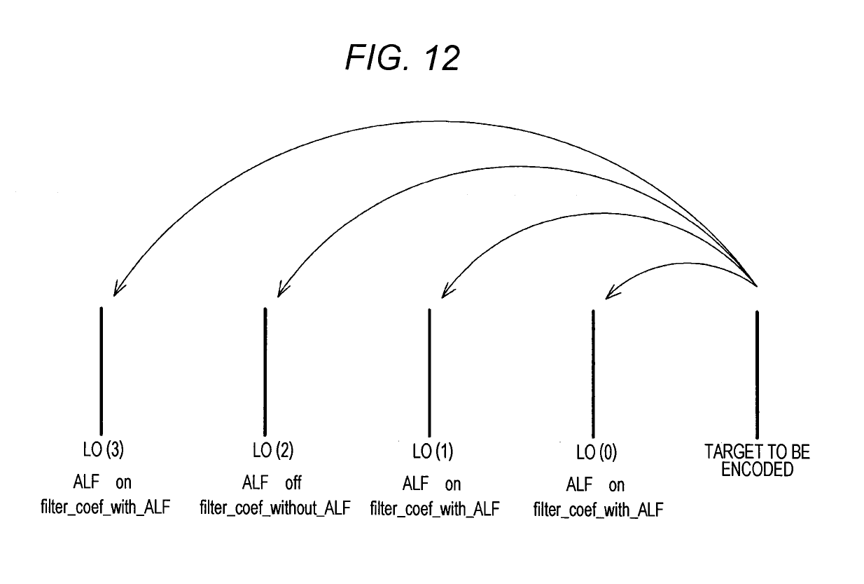

FIG. 12 is a diagram illustrating an example in which the execution or non-execution of the adaptive loop filter process is switched in units of frames. In FIG. 12, frames L0 (0), L0 (1), and L0 (3) are frames (ALF ON) for which the adaptive loop filter process is performed in all of the areas in the frame. The frame L0 (2) is a frame (ALF OFF) for which the adaptive loop filter process is not performed in all of the areas in the frame.

For example, when the predicted image data is generated using L0 (0) as the reference frame, filter_coef_without_ALF according to the decimal part of the motion vector is selected from filter_coef_set_wo_ALF. When the predicted image data is generated using L0 (2) as the reference frame, filter_coef_without_ALF according to the decimal part of the motion vector is selected from filter_coef_set_wo_ALF.

In step ST66, the motion prediction/compensation unit 32 generates the predicted image data. The filter unit 3233 of the motion prediction/compensation unit 32 generates the predicted image data by performing the filter process on the reference image data using the filter coefficient supplied from the coefficient table 3232 in step ST64 or step ST65.

Thus, in the motion compensation process of step ST52 in FIG. 10, the predicted image data is generated, as described above, and then the process proceeds to step ST53.

In step ST53, the motion prediction/compensation unit 32 calculates the cost function values. The motion prediction/compensation unit 32 calculates the cost function values using the input image data of the prediction unit to be encoded, the predicted image data generated in step ST52, and the like, as described above, and then the process proceeds to step ST54.

In step ST54, the motion prediction/compensation unit 32 determines the optimum inter-prediction mode. The motion prediction/compensation unit 32 determines the reference index in which the cost function value calculated in step ST53 is the minimum value, the block size of the coding unit, and the shape and size of the prediction unit in the coding unit, and sets the optimum inter-prediction mode. When the mode in which the cost function is the minimum is determined, the cost function value when the inter-prediction is performed in a skip mode is also used.

When the predicted image and optimum mode selection unit 33 selects the optimum inter-prediction mode as the optimum prediction mode, the motion prediction/compensation unit 32 generates the predicted image data so that the predicted image data of the optimum inter-prediction mode can be supplied to the subtraction unit 13 and the addition unit 23.

Thus, in the image encoding device 10, when the reference image data used to generate the predicted image data is not subjected to the adaptive loop filter process, the coefficient of the filter characteristics in which the noise removal strength is increased is selected as the filter coefficient used for the reference image data. Therefore, since the predicted image data with small noise can be generated, the deterioration in the quality of the predicted image can be reduced, and thus deterioration in the compression efficiency can be suppressed. Further, when the reference image data used to generate the predicted image data is subjected to the adaptive loop filter process, for example, the coefficient with filter characteristics preserving components from a low-frequency component to a high-frequency component is selected as the filter coefficient used for the reference image data. Therefore, the deterioration in the encoding efficiency can be prevented by causing the motion prediction/compensation unit 32 to perform the filter process on the reference image data to which the filter is applied in the adaptive loop filter process.

Even when the loop filter unit 24 adaptively performs the deblocking filter process, the deterioration in the encoding efficiency can be suppressed by switching the filter characteristics depending on whether the reference image data is likewise subjected to the deblocking filter process.

### <3. Configuration of Image Decoding Device>

Next, a case in which the image processing device is applied to an image decoding device will be described. The image compression information generated by encoding the input image is supplied to the image decoding device via a predetermined transmission path, a recording medium, or the like and is decoded.

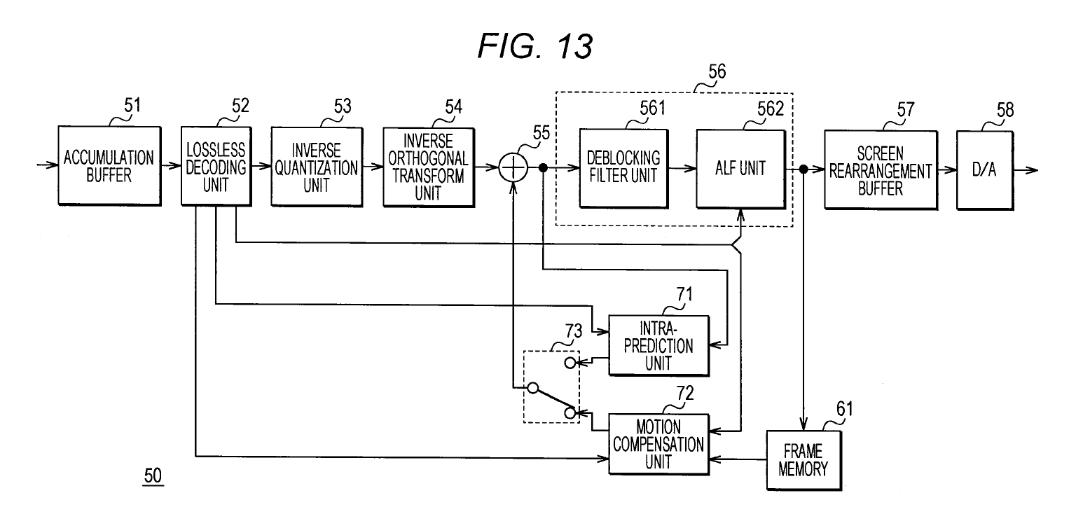

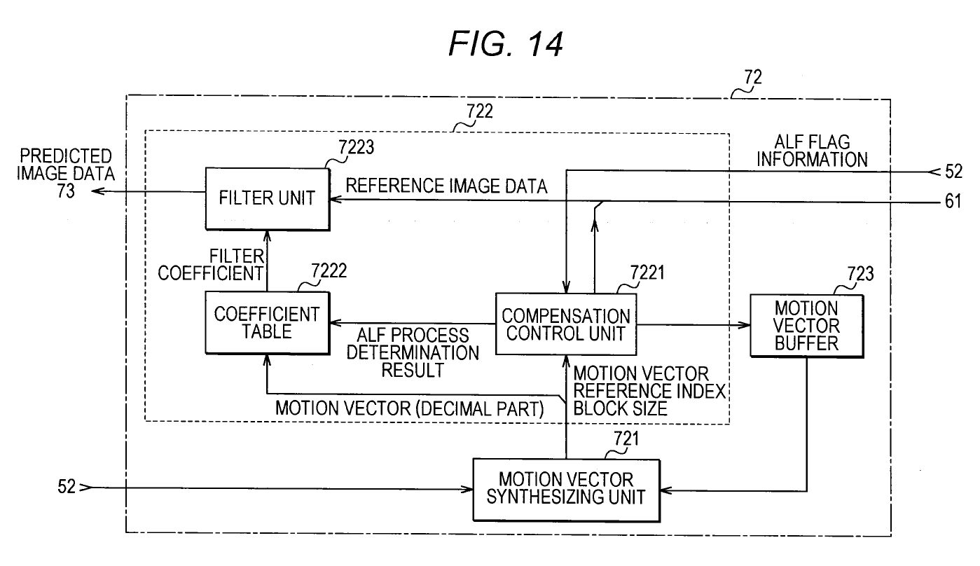

FIG. 13 is a diagram illustrating the configuration of the image decoding device. An image decoding device 50 includes an accumulation buffer 51, a lossless decoding unit 52, an inverse quantization unit 53, an inverse orthogonal transform unit 54, an addition unit 55, a loop filter unit 56, a screen rearrangement buffer 57, a digital/analog conversion unit (D/A conversion unit) 58. The image decoding device 50 further includes a frame memory 61, selectors 62 and 73, an intra-prediction unit 71, a motion compensation unit 72. The loop filter unit 56 includes, for example, a deblocking filter unit 561 and an ALF (Adaptive Loop Filter) unit 562.

The accumulation buffer 51 accumulates the transmitted image compression information. The lossless decoding unit 52 decodes the image compression information supplied from the accumulation buffer 51 according to a scheme corresponding to the encoding scheme of the lossless encoding unit 16 in FIG. 3.

The lossless decoding unit 52 outputs the prediction mode information obtained by decoding the image compression information to the intra-prediction unit 71 or the motion compensation unit 72. Further, the lossless decoding unit 52 outputs the differential motion vector obtained by decoding the image compression information or the loop filter information obtained from the image compression information to the motion compensation unit 72.

The inverse quantization unit 53 performs inverse quantization on the quantization data decoded by the lossless decoding unit 52 according to a scheme corresponding to the quantization scheme of the quantization unit 15 in FIG. 3. The inverse orthogonal transform unit 54 performs inverse orthogonal transform on the output of the inverse quantization unit 53 according to a scheme corresponding to the orthogonal transform scheme of the orthogonal transform unit 14 in FIG. 3 and outputs data to the addition unit 55.

The addition unit 55 adds the data obtained after the inverse orthogonal transform to the predicted image data supplied from the selector 73 to generate decoded image data and outputs the decoded image data to the deblocking filter unit 561 and the intra-prediction unit 71.

The loop filter unit 56 performs the same filter process as that of the loop filter unit 24 of the image encoding device 10 and stores the reference image data from which noise is removed in the frame memory 61.

The deblocking filter unit 561 of the loop filter unit 56 performs a deblocking filter process on the decoded image data supplied from the addition unit 55 to remove block distortion and outputs the decoded image data to the ALF unit 562.

The ALF unit 562 performs an adaptive loop filter process based on the filter information supplied from the lossless decoding unit 52, supplies the processed decoded image data to the frame memory 61 to accumulate the decoded image data, and outputs the decoded image data to the screen rearrangement buffer 57.

The screen rearrangement buffer 57 sorts images. That is, the order of the frames sorted in the encoding order by the screen rearrangement buffer 12 in FIG. 3 is sorted to the original display order, and the original display order is output to the D/A conversion unit 58.

The D/A conversion unit 58 performs the D/A conversion on the image data supplied from the screen rearrangement buffer 57 and outputs the image data to a display (not illustrated) to display the images.

The frame memory 61 stores the decoded image data obtained after the filter process by the loop filter unit 24 as reference image data.

The intra-prediction unit 71 generates the predicted image data based on the prediction mode information supplied from the lossless decoding unit 52 and the decoded image data supplied from the addition unit 55 and outputs the generated predicted image data to the selector 73.

The motion compensation unit 72 reads the reference image data from the frame memory 61 based on the prediction mode information or the differential motion vector supplied from the lossless decoding unit 52, generates the predicted image data, and outputs the generated predicted image data to the selector 73.

The motion compensation unit 72 reads the reference image data from the frame memory 61 based on the prediction mode information and the differential motion vector supplied from the lossless decoding unit 52 and performs motion compensation to generate the predicted image data. The motion compensation unit 72 outputs the generated predicted image data to the selector 73. The motion compensation unit 72 switches the filter characteristics based on the loop filter information and generates the predicted image data.

Based on the prediction mode information supplied from the lossless decoding unit 52, the selector 73 selects the intra-prediction unit 71 in a case of the intra-prediction and selects the motion compensation unit 72 in a case of the inter-prediction. The selector 73 outputs the predicted image data generated by the selected intra-prediction unit 71 or the selected motion compensation unit 72 to the addition unit 55.

FIG. 14 is a diagram illustrating the configuration of the motion compensation unit 72. The motion compensation unit 72 includes a motion vector synthesizing unit 721, a motion compensation processing unit 722, and a motion vector buffer 723. FIG. 14 illustrates a case in which the filter coefficient when the adaptive loop filter process is not performed in the reference image data is switched to a coefficient for which noise removal strength is enhanced, compared to the filter coefficient when the adaptive loop filter process is performed.

The motion vector synthesizing unit 721 adds the differential motion vector and the prediction motion vector of the decoding target prediction unit supplied from the lossless decoding unit 52 to calculate a motion vector of the prediction unit and outputs the motion vector to the motion compensation processing unit 722. The motion vector synthesizing unit 721 generates a prediction motion vector by performing median prediction or the like, for example, using the motion vector of adjacent prediction units stored in the motion vector buffer 723.

The motion compensation processing unit 722 includes a compensation control unit 7221, a coefficient table 7222, and a filter unit 7223. The compensation control unit 7221 reads the reference image data from the frame memory 61 based on the prediction mode information supplied from the lossless decoding unit 52 and the motion vector supplied from the motion vector synthesizing unit 721. The compensation control unit 7221 determines whether the read reference image data is subjected to the adaptive loop filter process based on the ALF flag information supplied from the lossless decoding unit 52 and outputs an ALF process determination result to the coefficient table 7222. For example, when the compensation control unit 7221 determines that the reference image data is subjected to the adaptive loop filter process based on the ALF flag information, the compensation control unit 7221 sets alf_applied_flag as the ALF process determination result to be true. Conversely, when the compensation control unit 7221 determines that the reference image data is not subjected to the adaptive loop filter process, the compensation control unit 7221 sets alf_applied_flag to be false. The compensation control unit 7221 outputs alf_applied_flag indicating the ALF process determination result to the coefficient table 7222.

The coefficient table 7222 is supplied with a decimal part of the motion vector and the ALF process determination result generated by the compensation control unit 7221. As in the coefficient table 3232 of the image encoding device 10, the coefficient table 7222 stores a filter coefficient set (“filter_coef_set_wo_ALF”) used for the reference image data not subjected to the adaptive loop filter process and a filter coefficient set (“filter_coef_set_w_ALF”) used for the reference image data subjected to the adaptive loop filter process.

The coefficient table 7222 outputs the filter coefficient selected according to the decimal part of the motion vector and the ALF process determination result to the filter unit 7223. For example, when alf_applied_flag is true, the coefficient table 7222 selects the filter coefficient according to the decimal part of the motion vector from filter_coef_set_w_ALF and outputs the filter coefficient to the filter unit 7223. Further, when alf_applied_flag is false, the coefficient table 7222 selects the filter coefficient according to the decimal part of the motion vector from the filter_coef_set_wo_ALF and outputs the filter coefficient to the filter unit 7223.

The filter unit 7223 performs an interpolation filter process of obtaining given predicted image data with the decimal pixel accuracy in the reference image data of a current block by using the filter coefficient supplied from the coefficient table 7222. When the reference image data is not subjected to the adaptive loop filter process, the filter unit 7223 performs the filter process with the filter characteristics in which the noise removal strength is enhanced, compared to the filter coefficient used for the reference image data subjected to the adaptive loop filter process. The filter unit 7223 outputs the predicted image data obtained by performing the filter process on the reference image data to the selector 73 illustrated in FIG. 13. When the selected filter coefficient is included in the image compression information, the filter coefficient included in the image compression information may be stored in the coefficient table 7222, and the filter unit 7223 may perform the interpolation filter process using the filter coefficient stored in the coefficient table 7222 and output the predicted image data to the selector 73.

Based on the prediction mode information supplied from the lossless decoding unit 52, the selector 73 selects the intra-prediction unit 71 in the case of the intra-prediction and selects the motion compensation unit 72 in the case of the inter-prediction. The selector 73 outputs the predicted image data generated by the selected intra-prediction unit 71 or the selected motion compensation unit 72 to the addition unit 55.

### <4. Process of Image Decoding Device>

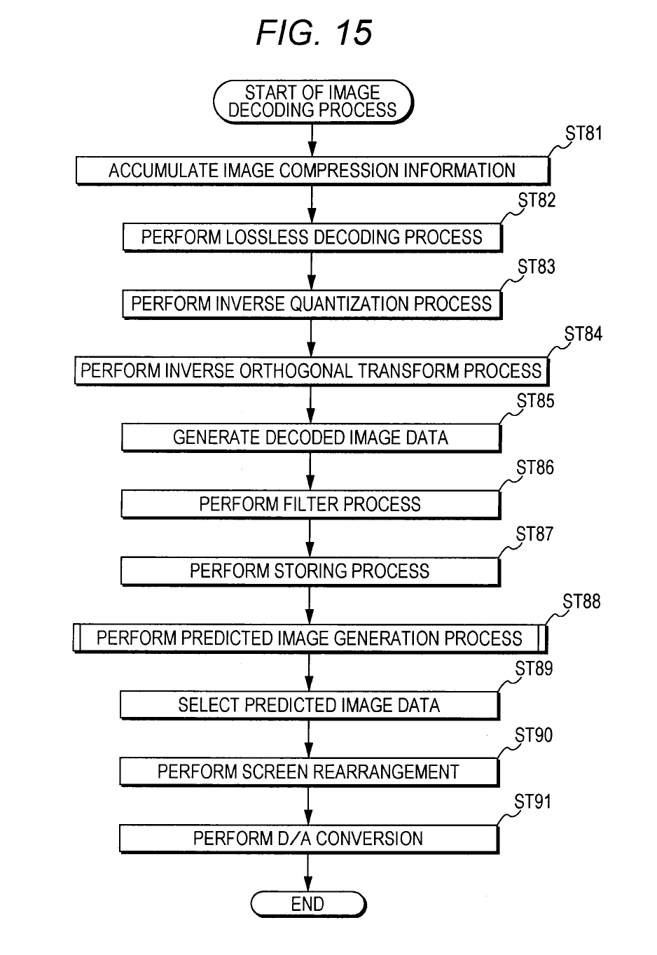

Next, an image decoding process performed by the image decoding device 50 will be described with reference to the flowchart of FIG. 15.

In step ST81, the accumulation buffer 51 accumulates the supplied image compression information. In step ST82, the lossless decoding unit 52 performs a lossless decoding process. The lossless decoding unit 52 decodes the image compression information supplied from the accumulation buffer 51. That is, quantization data of each picture encoded by the lossless encoding unit 16 in FIG. 3 can be obtained. The lossless decoding unit 52 performs the lossless decoding on the prediction mode information included in the image compression information. When the obtained prediction mode information is information on the intra-prediction mode, the prediction mode information is output to the intra-prediction unit 71. When the prediction mode information is information on the inter-prediction mode, the lossless decoding unit 52 outputs the prediction mode information to the motion compensation unit 72. The lossless decoding unit 52 outputs the differential motion vector obtained by decoding the image compression information or the loop filter information obtained from the image compression information to the motion compensation unit 72.

In step ST83, the inverse quantization unit 53 performs an inverse quantization process. The inverse quantization unit 53 performs the inverse quantization on the quantization data decoded by the lossless decoding unit 52 with characteristics corresponding to the characteristics of the quantization unit 15 in FIG. 3.

In step ST84, the inverse orthogonal transform unit 54 performs an inverse orthogonal transform process. The inverse orthogonal transform unit 54 performs the inverse orthogonal transform on the transform coefficient data subjected to the inverse quantization by the inverse quantization unit 53 with characteristics corresponding to the characteristics of the orthogonal transform unit 14 in FIG. 3.

In step ST85, the addition unit 55 generates the decoded image data. The addition unit 55 generates the decoded image data by adding the data obtained by performing the inverse orthogonal transform process to the predicted image data selected in step ST89 to be described below. Thus, the original image is decoded.

In step ST86, the deblocking filter unit 561 performs a filter process. The deblocking filter unit 561 removes block distortion contained in the decoded image by performing a deblocking filter process on the decoded image data output from the addition unit 55.

In step ST87, the frame memory 61 performs a process of storing the decoded image data. The decoded image data stored in the frame memory 61 or the decoded image data output from the addition unit 55 is used to generate the predicted image data as the reference image data.

In step ST88, the intra-prediction unit 71 and the motion compensation unit 72 perform prediction processes. The intra-prediction unit 71 and the motion compensation unit 72 each perform the prediction process according to the prediction mode information supplied from the lossless decoding unit 52.

That is, when the prediction mode information of the intra-prediction is supplied from the lossless decoding unit 52, the intra-prediction unit 71 generates the predicted image data based on the prediction mode information. Further, when the prediction mode information of the inter-prediction is supplied from the lossless decoding unit 52, the motion compensation unit 72 generates the predicted image data by performing the motion compensation based on the prediction mode information.

In step ST89, the selector 73 selects the predicted image data. The selector 73 selects the predicted image supplied from the intra-prediction unit 71 and the predicted image data supplied from the motion compensation unit 72, supplies the selected predicted image data to the addition unit 55, and adds the predicted image data to the output of the inverse orthogonal transform unit 54 in step ST85, as described above.

In step ST90, the screen rearrangement buffer 57 performs image sorting. That is, the screen rearrangement buffer 57 sorts the order of the frames sorted for the encoding by the screen rearrangement buffer 12 of the image encoding device 10 in FIG. 3 to the original display order.

In step ST91, the D/A conversion unit 58 performs the D/A conversion on the image data from the screen rearrangement buffer 57. The image is output to a display (not illustrated) and the image is displayed.

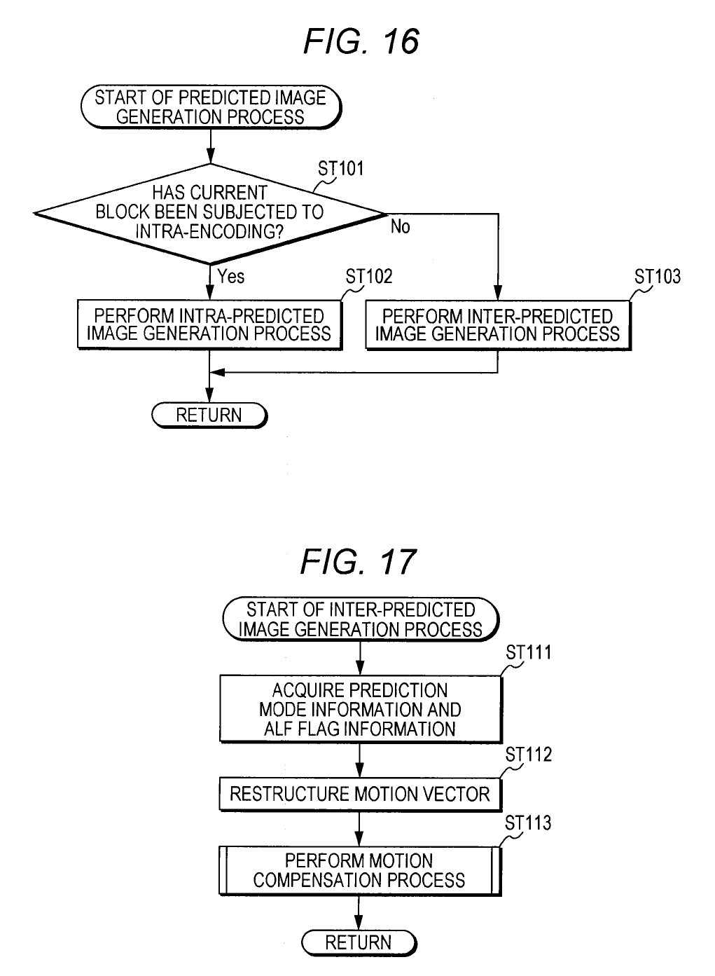

Next, the prediction process of step ST88 in FIG. 15 will be described with reference to the flowchart of FIG. 16.

In step ST101, the lossless decoding unit 52 determines whether the prediction unit to be decoded is subjected to the intra-encoding. When the prediction mode information obtained by performing the lossless decoding is the prediction mode information of the intra-prediction, the lossless decoding unit 52 supplies the prediction mode information to the intra-prediction unit 71, and then the process proceeds to step ST102. Further, the prediction mode information is the prediction mode information of the inter-prediction, the lossless decoding unit 52 supplies the prediction mode information to the motion compensation unit 72, and then the process proceeds to step ST103.

In step ST102, the intra-prediction unit 71 performs the intra-prediction process. The intra-prediction unit 71 generates the predicted image data by performing the intra-prediction using the decoded image data supplied from the addition unit 55 and not subjected to the deblocking filter process and the prediction mode information.

In step ST103, the motion compensation unit 72 performs the inter-prediction process. The motion compensation unit 72 reads the reference image data from the frame memory 61 and generates the predicted image data based on information such as the prediction mode information supplied from the lossless decoding unit 52.

FIG. 17 is a flowchart illustrating the inter-prediction process of step ST103. In step ST111, the motion compensation unit 72 acquires the prediction mode information and the ALF flag information. The motion compensation unit 72 acquires the prediction mode information and the ALF flag information from the lossless decoding unit 52, and then the process proceeds to step ST112. The ALF unit 562 performs the filter process using the ALF flag information acquired from the lossless decoding unit 52 and the filter coefficient.

In step ST112, the motion compensation unit 72 restructures the motion vector. The motion compensation unit 72 restructures the motion vector of the prediction unit, for example, by adding a prediction motion vector generated through median prediction or the like using the motion vectors of the adjacent prediction units to the differential motion vector supplied from the lossless decoding unit 52, and then the process proceeds to step ST113.

In step ST113, the motion compensation unit 72 performs the motion compensation process. The motion compensation unit 72 reads the reference image data from the frame memory 61 based on the prediction mode information acquired in step ST111 or the motion vector restructured in step ST112. The motion compensation unit 72 generates the predicted image data by performing the filter process on the read reference image data based on the motion vector or the ALF flag information, as in the motion compensation process illustrated in FIG. 11.

Thus, as in the image encoding device 10, in the image decoding device 50, the coefficient with the filter characteristics in which the noise removal strength is enhanced is selected as the filter coefficient used for the reference image data, when the reference image data used to generate the predicted image data is not subjected to the adaptive loop filter process in the inter-prediction. Further, when the reference image data used to generate the predicted image data is subjected to the adaptive loop filter process, for example, the coefficient with the filter characteristics preserving components from a low-frequency component to a high-frequency component is selected as the filter coefficient used for the reference image data. Therefore, even when the image compression information is generated using the filter coefficient according to the adaptive loop filter process by the image encoding device 10, the image decoding device 50 can perform the decoding process corresponding to the encoding process of the image encoding device 10. When the image compression information is generated using the filter coefficient according to the deblocking filter process by the image encoding device 10, the image decoding device 50 can perform the decoding process corresponding to the encoding process of the image encoding device 10 by transforming the filter characteristics depending on whether the reference image data is subjected to the deblocking filter process by the motion compensation unit 71.

### <5. Another Configuration and Process of Image Encoding Device>

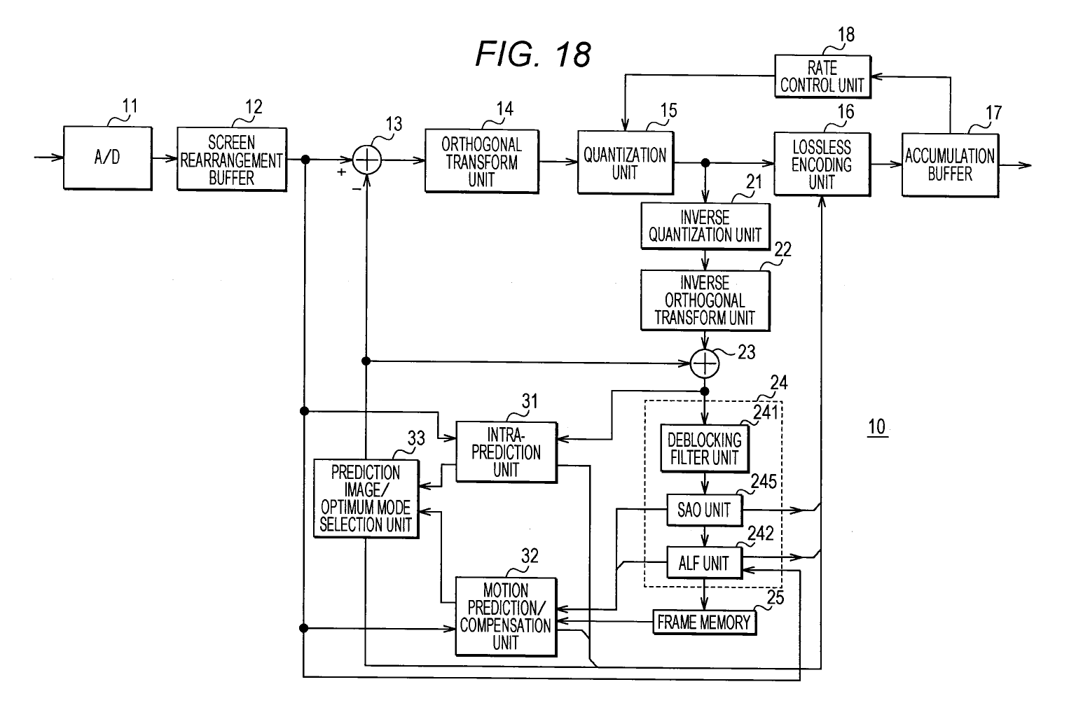

FIG. 18 is a diagram illustrating another configuration when the image processing device is applied to an image encoding device. In another configuration of the image encoding device, a loop filter unit 24 includes an SAO (Sample Adaptive Offset) 245 between a deblocking filter unit 241 and an ALF (Adaptive Loop Filter) unit 242. The SAO corresponds to the above-described PQAO (Picture Quality Adaptive Offset).

As the kinds of offset, there are two kinds of offset called band offset and six kinds of offset called edge offset. Further, the offset may not be adapted. An image can be partitioned in a quad-tree and execution of encoding can be selected in each area according to one of the above-described kinds of offset.

This selection information can be encoded by the lossless encoding unit 16 and can be included in a bit stream. By using this method, the encoding efficiency can be improved.

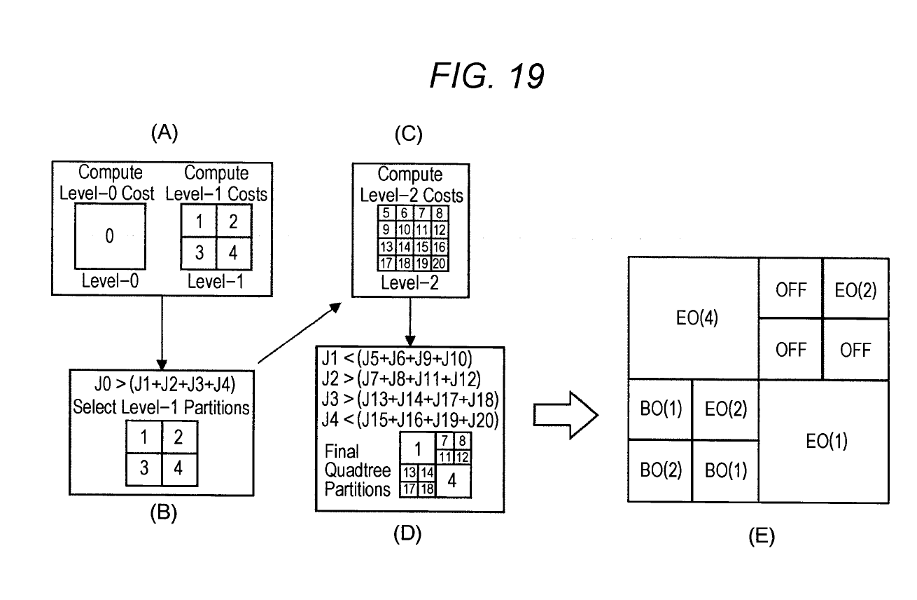

Hereinafter, a quad-tree structure will be described with reference to FIG. 19. For example, in the image encoding device 10, a cost function value J0 of Level-0 (partition depth 0) indicating that an area 0 is not partitioned is calculated, as illustrated in (A) of FIG. 19. Further, cost function values J1, J2, J3, and J4 of Level-1 (partition depth 0) indicating that the area 0 is partitioned into four areas, areas 1 to 4, are calculated.

As illustrated in (B) of FIG. 19, the cost function values are compared to each other and the partitioned areas (Partitions) of Level-1 in which the cost function value is small are selected by “J0>(J1+J2+J3+J4).”

Likewise, as illustrated in (C) of FIG. 19, cost function values J5 to J20 of Level-2 (partition depth 2) indicating that the area 0 is partitioned sixteen areas, areas 5 to 20, are calculated.

As illustrated in (D) of FIG. 19, the cost function values are compared to each other and the partitioned areas (Partitions) of Level-1 are selected in the area 1 by “J1<(J5+J6+J9+J10).” In the area 2, the partitioned areas (Partitions) of Level-2 are selected by “J2>(J7+J8+J11+J12).” In the area 3, the partitioned areas (Partitions) of Level-2 are selected by “J3>(J13+J14+J17+J18).” In the area 4, the partitioned areas (Partitions) of Level-1 are selected by “J4>(J15+J16+J19+J20).”

As a result, the final Quad-tree areas (Partitions) are determined in the Quad-tree structure, as illustrated in (D) of FIG. 19. In each of the determined areas of the Quad-tree structure, the cost function values are calculated for all of the two kinds of band offset, the six kinds of edge offset, and non-offset and the offset by which the encoding is performed is determined.

For example, in the area 1, EO (4), that is, the fourth kind of edge offset is determined among the edge offsets, as illustrated in (E) of FIG. 19. In the area 7, OFF, that is, the non-offset is determined. In the area 8, EO (2), that is, the second kind of edge offset is determined among the edge offsets. In the areas 11 and 12, OFF, that is, the non-offset is determined.

In the area 13, BO (1), that is, the first kind of band offset is determined among the band offsets. In the area 14, EO (2), that is, the second kinds of edge offset is determined among the edge offsets. In the area 17, BO (2), that is, the second kind of band offset is determined among the band offsets. In the area 18, BO (1), that is, the first kind of band offset is determined among the band offsets. In the area 4, EO (1), that is, the first kind of edge offset is determined among the edge offsets.

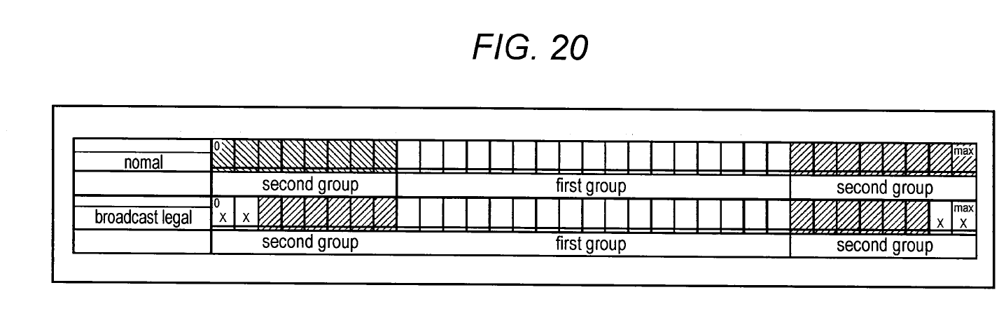

Next, the band offsets will be described in detail with reference to FIG. 20. In regard to the band offsets, in the example of FIG. 20, 1 scale indicates “1 band=8 pixels,” the luminance pixel values can be divided into 32 bands, and each band independently has an offset value. That is, in the example of FIG. 20, among 0 to 255 pixels (32 bands), 16 middle bands can be classified to a first group and each 8 bands on both sides can be classified to a second group.

The offsets of only one of the first and second groups are encoded and transmitted to the decoding side. In general, black and white is distinct or subtle shade is realized in one area in many cases, and thus a case in which pixels are present in all of the first and second groups is rare. Therefore, by sending only one side of the offset, in each Quad-tree area, an amount of encoding is prevented from increasing due to the transmission of the pixel value of a value which is not included.

When input signals are broadcast, luminance signals are restricted within the range of 16,235 and color-difference signals are restricted within the range of 16,240. At this time, broadcast legal illustrated in the lower part of FIG. 20 is applied, and thus offset values of each two bands indicated by x marks on both sides are not transmitted.

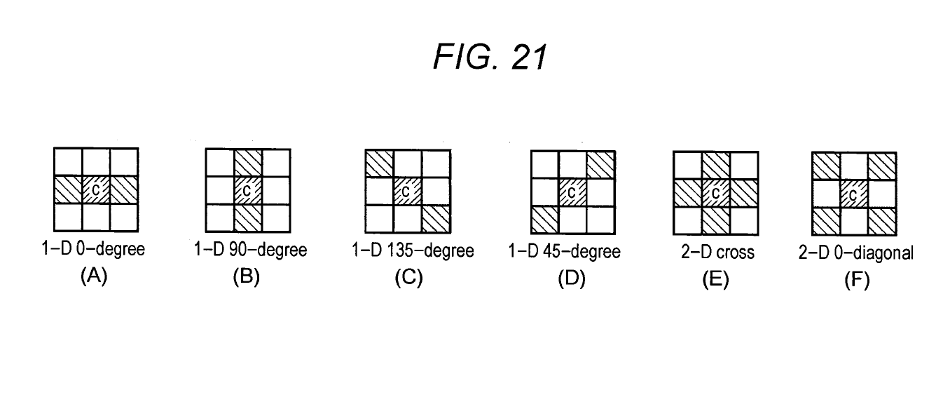

Next, the edge offsets will be described in detail with reference to FIG. 21. In the edge offsets, a corresponding pixel value is compared to neighboring pixel values neighboring on this pixel value and an offset value is transmitted for a category corresponding thereto.

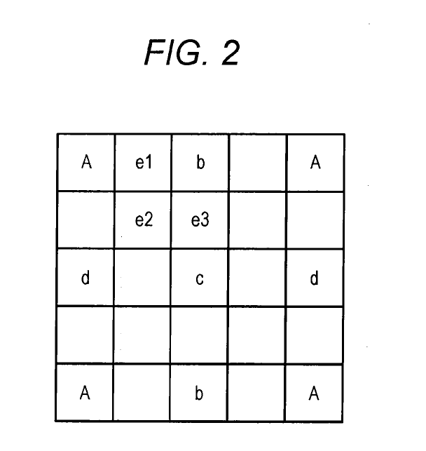

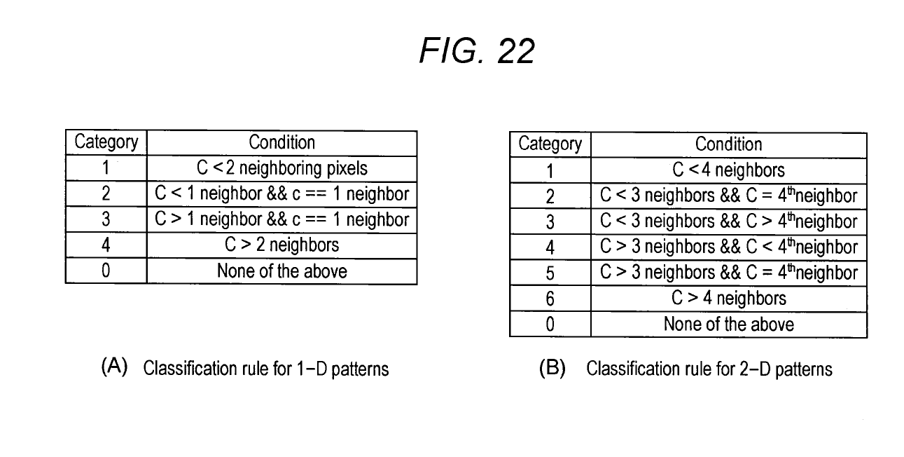

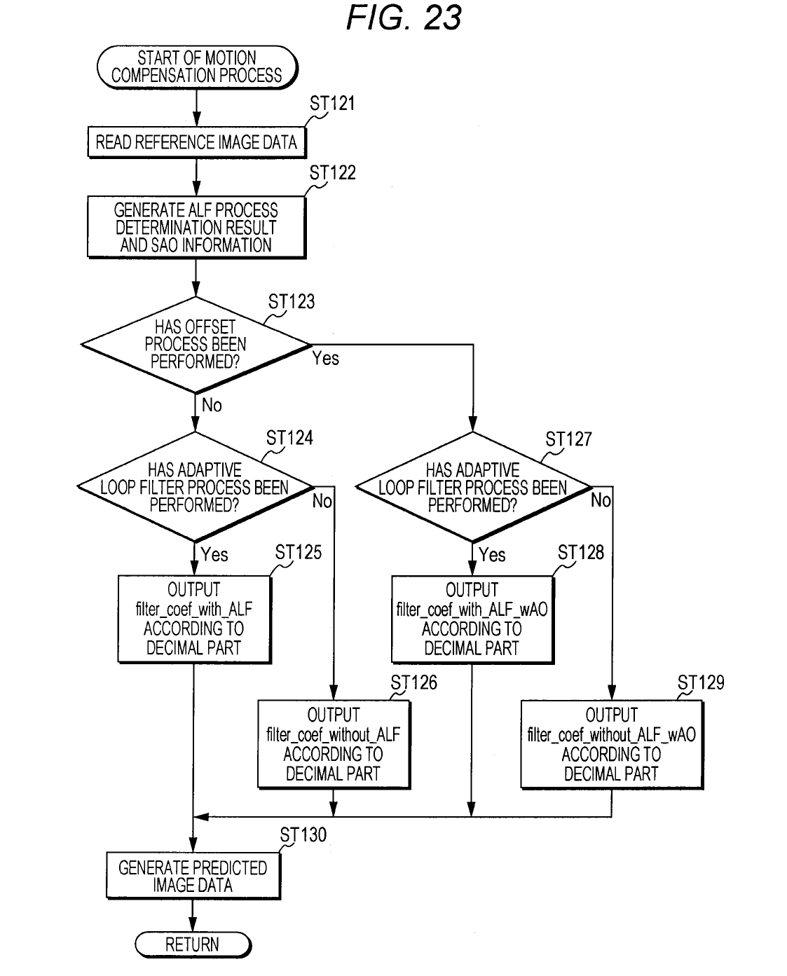

In the edge offsets, there are 4 one-dimensional patterns illustrated in (A) to (D) of FIG. 21 and 2 two-dimensional patterns illustrated in (E) and (F) of FIG. 21, each offset is transmitted with categories illustrated in FIG. 22.

In (A) of FIG. 21, neighboring pixels are disposed one-dimensionally on the right and left sides of a pixel C. That is, a 1-D 0-degree pattern forming 0 degrees with respect to the pattern of (A) of FIG. 21 is illustrated. In (B) of FIG. 21, neighboring pixels are disposed one-dimensionally on the upper and lower sides of the pixel C. That is, a 1-D 90-degree pattern forming 90 degrees with respect to the pattern of (A) of FIG. 21 is illustrated.

In (C) of FIG. 21, neighboring pixels are disposed one-dimensionally on the upper left and lower right sides of the pixel C. That is, a 1-D 135-degree pattern forming 135 degrees with respect to the pattern of (A) of FIG. 21 is illustrated. In (D) of FIG. 21, neighboring pixels are disposed one-dimensionally on the upper right and lower left sides of the pixel C. That is, a 1-D 135-degree pattern forming 45 degrees with respect to the pattern of (A) of FIG. 21 is illustrated.

In (E) of FIG. 21, neighboring pixels are disposed two-dimensionally on the upper, lower, right, and left sides of the pixel C. That is, a 2-D cross pattern in which the pixel C is crossed is illustrated. In (F) of FIG. 21, neighboring pixels are disposed two-dimensionally on the upper right, lower left, upper left, and lower right sides of the pixel C. That is, a 2-D diagonal pattern in which the pixel C is diagonally crossed is illustrated.

(A) of FIG. 22 illustrates a rule list (Classification rule for 1-D patterns) of the one-dimensional patterns. The patterns in (A) to (D) of FIG. 21 are classified to five kinds of category illustrated in (A) of FIG. 22, the offsets are calculated by the category, and the offsets are transmitted to the decoding unit.

When the pixel value of the pixel C is less than the pixel values of two neighboring pixels, the pattern is classified to category 1. When the pixel value of the pixel C is less than the pixel value of one neighboring pixel and is equal to the pixel value of the other neighboring pixel, the pattern is classified to category 2. When the pixel value of the pixel C is greater than the pixel value of one neighboring pixel and is equal to the pixel value of the other neighboring pixel, the pattern is classified to category 3. When the pixel value of the pixel C is greater than the pixel values of two neighboring pixels, the pattern is classified to category 4. In none of the above, the pattern is classified to category 0.

(B) of FIG. 22 illustrates a rule list (Classification rule for 2-D patterns) of the two-dimensional patterns. The patterns in (E) and (F) of FIG. 21 are classified to seven kinds of category illustrated in (B) of FIG. 22 and the offsets are transmitted to the decoding unit by the category.

When the pixel value of the pixel C is less than the pixel values of the four neighboring pixels, the pattern is classified to category 1. When the pixel value of the pixel C is less than the pixel values of three neighboring pixels and is equal to the pixel value of the fourth neighboring pixel, the pattern is classified to category 2. When the pixel value of the pixel C is less than the pixel values of three neighboring pixels and is greater than the pixel value of the fourth neighboring pixel, the pattern is classified to category 3.

When the pixel value of the pixel C is greater than the pixel values of three neighboring pixels and is less than the pixel value of the fourth neighboring pixel, the pattern is classified to category 4. When the pixel value of the pixel C is greater than the pixel values of three neighboring pixels and is equal to the pixel value of the fourth neighboring pixel, the pattern is classified to category 5. When the pixel value of the pixel C is greater than the pixel values of the four neighboring pixels, the pattern is classified to category 6. In none of the above, the pattern is classified to category 0.

As described above, in the edge offset, the amount of calculation is decreased for the one-dimensional pattern, since comparison only with two neighboring pixels may be performed. In a high efficiency encoding condition, the value of 1-bit offset is transmitted to the decoding side with higher accuracy, compared to the low delay encoding condition.

As described above, the offset process is adaptively performed. The offset process may be performed only on the luminance signal or may be performed on the luminance signal and the color-difference signal.

The motion prediction/compensation unit 32 generates the predicted image data by switching the filter coefficient when the SAO unit 245 does not perform the offset process to the coefficient in which the noise removal strength is enhanced, compared to the filter coefficient when the offset process is performed.

In this case, the coefficient table 3232 is supplied with the decimal part of the motion vector, the ALF process determination result generated by the compensation control unit 3231, and the SAO information on the offset process from the SAO unit 245. When the offset process is not performed by the SAO unit 245, the coefficient table 3232 has the filter coefficient (filter_coef_without_ALF) used for the reference image data not subjected to the adaptive loop filter process and the filter coefficient (filter_coef_with_ALF) used for the reference image data subjected to the adaptive loop filter process. When the offset process is performed by the SAO unit 245, the coefficient table 3232 has a filter coefficient (filter_coef_without_ALF-wAO) used for the reference image data not subjected to the adaptive loop filter process and a filter coefficient (filter_coef_with_ALF_wAO) used for the reference image data subjected to the adaptive loop filter process. The coefficient table 3232 stores a filter coefficient set, when the offset process is not performed by the SAO unit 245, and a filter coefficient set, when the offset process is performed.

The filter coefficient when the offset process is not performed by the SAO unit 245 is set to the filter coefficient in which the noise removal strength is enhanced more than the filter coefficient when the offset process is performed by the SAO unit 245.

The filter unit 3233 performs an interpolation filter process of obtaining given predicted image data with the decimal pixel accuracy in the reference image data of a current block using the filter coefficient selected based on the decimal part of the motion vector, the ALF process determination result, and the SAO information in the coefficient table 3232. When the mode determination unit 322 calculates the cost function value to determine the optimum inter-prediction mode, the filter unit 3233 outputs the generated predicted image data to the mode determination unit 322. The filter unit 3233 outputs the predicted image data generated in the optimum inter-prediction mode to the predicted image and optimum mode selection unit 33.

FIG. 23 is a flowchart illustrating the motion compensation process. In step ST121, the motion prediction/compensation unit 32 reads the reference image data. The compensation control unit 3231 of the motion prediction/compensation unit 32 determines a reading area based on the size of the prediction unit performing the motion compensation, the motion vector detected for the prediction unit performing the motion compensation, and the reference index indicating the reference image used to detect the motion vector. Further, the compensation control unit 3231 reads the image data of the determined reading area from the frame memory 25, and then the process proceeds to step ST122.

In step ST122, the motion prediction/compensation unit 32 generates the ALF process determination result and the SAO information. The compensation control unit 3231 of the motion prediction/compensation unit 32 generates the ALF process determination result by determining whether the reference image data is subjected to the adaptive loop filter process based on the flag information generated by the ALF unit 242. The compensation control unit 3231 acquires the SAO information from the SAO unit 245, and then the process proceeds to step ST123.

In step ST123, the motion prediction/compensation unit 32 determines whether the offset process is performed. When the motion prediction/compensation unit 32 determines that the offset process is performed based on the SAO information, the process proceeds to step ST124. When it is determined that the offset process is performed, the process proceeds to step ST127.

In step ST124, the motion prediction/compensation unit 32 determines whether the adaptive loop filter process is performed. When the adaptive loop filter process is performed on the reference image data read in step ST121, the motion prediction/compensation unit 32 cause the process to proceed to step ST125. When the adaptive loop filter process is not performed, the process proceeds to step ST126.

In step ST125, the motion prediction/compensation unit 32 outputs filter_coef_with_ALF according to the decimal part of the motion vector. When the ALF process determination result indicates application of the filter, the coefficient table 3232 of the motion prediction/compensation unit 32 selects filter_coef_with_ALF according to the decimal part of the motion vector from filter_coef_set_w_ALF and outputs filter_coef_with_ALF to the filter unit 3233. Then the process proceeds to step ST130.

In step ST126, the motion prediction/compensation unit 32 outputs filter_coef_with_ALF according to the decimal part of the motion vector. When the ALF process determination result does not indicate the application of the filter, the coefficient table 3232 of the motion prediction/compensation unit 32 selects filter_coef_without_ALF according to the decimal part of the motion vector from filter_coef_set_wo_ALF and outputs filter_coef_without_ALF to the filter unit 3233. Then, the process proceeds to step ST130.

In step ST127, the motion prediction/compensation unit 32 determines whether the adaptive loop filter process is performed. When the reference image data read in step ST121 is subjected to the adaptive loop filter process, the motion prediction/compensation unit 32 causes the process to proceed to step ST128. When the adaptive loop filter process is not performed, the process proceeds to step ST129.

In step ST128, the motion prediction/compensation unit 32 outputs filter_coef_with_ALF_wAO according to the decimal part of the motion vector. When the ALF process determination result indicates the application of the filter, the coefficient table 3232 of the motion prediction/compensation unit 32 selects filter_coef_with_ALF_wAO according to the decimal part of the motion vector from the filter coefficient set and outputs filter_coef_with_ALF_wAO to the filter unit 3233. Then, the process proceeds to step ST130.

In step ST129, the motion prediction/compensation unit 32 outputs filter_coef_with_ALF_wAO according to the decimal part of the motion vector. When the ALF process determination result does not indicate the application of the filter, the coefficient table 3232 of the motion prediction/compensation unit 32 selects filter_coef_without_ALF_wAO according to the decimal part of the motion vector from the filter coefficient set and outputs filter_coef_without_ALF_wAO to the filter unit 3233. Then, the process proceeds to step ST130.

Further, filter_coef_with_ALF is a coefficient in which the noise removal strength is enhanced more than that of filter_coef_with_ALF_wAO, and filter_coef_without_ALF is a coefficient in which the noise removal strength is enhanced more than that of filter_coef_without_ALF_wAO.

In step ST130, the motion prediction/compensation unit 32 generates the predicted image data. The filter unit 3233 of the motion prediction/compensation unit 32 generates the predicted image data by performing the filter process on the reference image data using the filter coefficients supplied from the coefficient table 3232 through the processes from step ST123 to step ST129.

Even when the SAO unit 245 is provided, the filter coefficient is switched depending on whether the offset process is performed by performing the above-described processes. When the offset process is not performed, the filter coefficient is considered as the filter coefficient in which the noise removal effect is high, and thus the deterioration in the encoding efficiency can be suppressed.

### <6. Another Configuration and Process of Image Decoding Device>

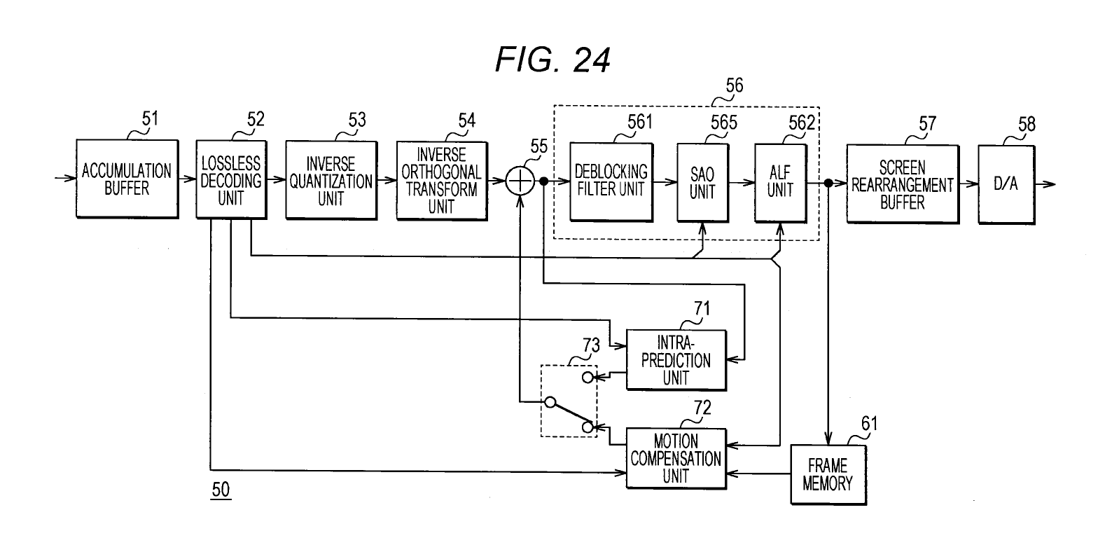

Next, another configuration and process in a case in which the image processing device is applied to the image decoding device will be described. FIG. 24 is a diagram illustrating the other configuration of the image decoding device. In the other configuration of the image decoding device, the loop filter unit 56 includes an SAO unit 565 between the deblocking filter unit 561 and the ALF (Adaptive Loop Filter) unit 562. The SAO unit 565 performs the same process as that of the SAO unit 245 of the image encoding device 10.

The motion compensation unit 72 reads the reference image data from the frame memory 61 based on the prediction mode information and the differential motion vector supplied from the lossless decoding unit 52 and performs motion compensation to generate the predicted image data. The motion compensation unit 72 outputs the generated predicted image data to the selector 73. The motion compensation unit 72 switches the filter characteristics based on information on the filter process of the loop filter unit and generates the predicted image data.

The motion compensation unit 72 generates the predicted image data by switching the filter coefficient when the SAO unit 565 does not perform the offset process to the coefficient in which the noise removal strength is enhanced, compared to the filter coefficient when the offset process is performed.

In this case, the coefficient table 7222 is supplied with the decimal part of the motion vector, the ALF process determination result generated by the compensation control unit 7221, and the SAO information indicating whether the filter process is performed from the SAO unit 565. The coefficient table 7222 has the filter coefficient (filter_coef_without_ALF) used for the reference image data not subjected to the adaptive loop filter process, the filter coefficient (filter_coef_with_ALF) used for the reference image data subjected to the adaptive loop filter process. The coefficient table 7222 further has the filter coefficient (filter_coef_without_ALF_wAO) used for the reference image data not subjected to the adaptive loop filter process and the filter coefficient (filter_coef_with_ALF_wAO) used for the reference image data subjected to the adaptive loop filter process, when the SAO unit 245 performs the offset process.

The filter unit 7223 performs an interpolation filter process of obtaining given predicted image data with the decimal pixel accuracy in the reference image data of a current block using the filter coefficient selected based on the decimal part of the motion vector, the ALF process determination result, and the SAO information in the coefficient table 7222. When the reference image data is not subjected to the offset process, the filter unit 7223 performs the filter process with the filter characteristics in which the noise removal strength is enhanced, compared to the filter coefficient used for the reference image data subjected to the offset process. The filter unit 7223 outputs the predicted image data obtained by performing the filter process on the reference image data to the selector 73. The motion compensation unit 72 can generate the predicted image data by performing the same processes as those of the flowchart illustrated in FIG. 23. When the selected filter coefficient is included in the image compression information, the filter coefficient included in the image compression information may be stored in the coefficient table 7222, and the filter unit 7223 may perform the interpolation filter process using the filter coefficient stored in the coefficient table 7222 and output the predicted image data to the selector 73.

Based on the prediction mode information supplied from the lossless decoding unit 52, the selector 73 selects the intra-prediction unit 71 in the case of the intra-prediction and selects the motion compensation unit 72 in the case of the inter-prediction. The selector 73 outputs the predicted image data generated by the selected intra-prediction unit 71 or the selected motion compensation unit 72 to the addition unit 55.

Thus, as in the image encoding device 10, in the image decoding device 50, the coefficient with the filter characteristics in which the noise removal strength is enhanced more than that of the filter coefficient used when the offset process is performed is selected as the filter coefficient used for the reference image data, when the offset process is not performed. Therefore, even when the image compression information is generated using the filter coefficient according to the offset process by the image encoding device 10, the image decoding device 50 can perform the decoding process corresponding to the encoding process of the image encoding device 10.

In the above-described embodiment, the ALF unit is configured to be provided. However, when the ALF unit is not provided, the filter coefficient may be set based on the SAO information or the like without using the ALF process determination result.

### 7. Case of Software Processing

The series of processes described in this specification can be performed by hardware, software, or a combination configuration of the hardware and software. When the processes are performed by software, a program recording the processing sequence is installed and executed in a memory of a computer embedded in dedicated hardware. Further, the program may be installed and executed in a general-purpose computer capable of performing various processes.

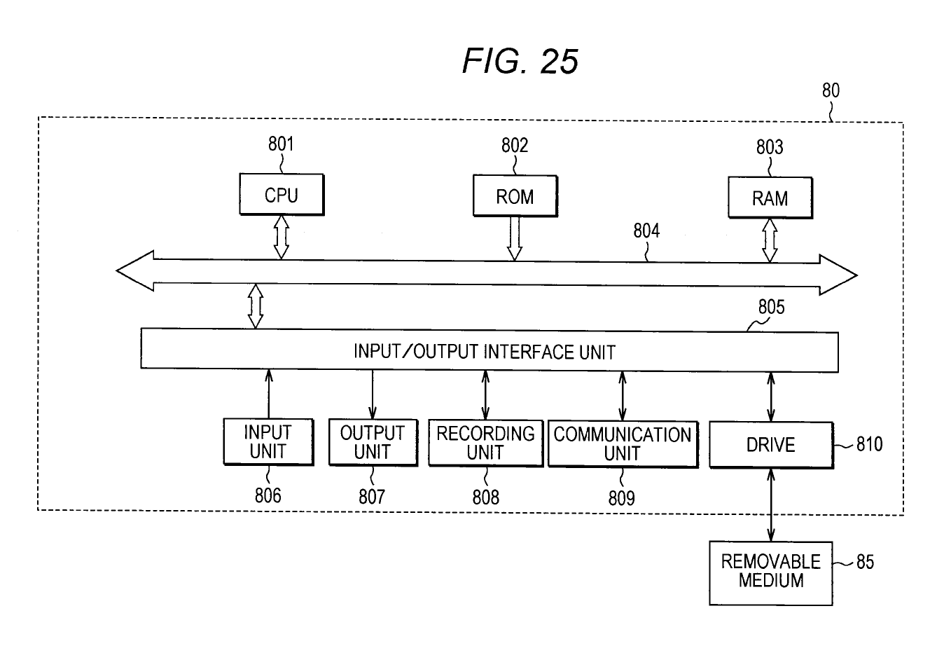

FIG. 25 is a diagram illustrating an example of the configuration of a computer apparatus that performs the series of processes described above by a program. A CPU 801 of a computer apparatus 80 executes various processes according to the program recorded on a ROM 802 or a recording unit 808.

A RAM 803 appropriately stores the program executed by the CPU 801, data, or the like. The CPU 801, the ROM 802, and the RAM 803 are connected to each other via a bus 804.

An input/output interface 805 is also connected to the CPU 801 via the bus 804. An input unit 806 such as a touch panel, a keyboard, a mouse, or a microphone and an output unit 807 configured by a display or the like are connected to the input/output interface 805. The CPU 801 performs various processes in response to instructions input from the input unit 806. Then, the CPU 801 outputs the processed results to the output unit 807.

The recording unit 808 connected to the input/output interface 805 is configured by, for example, a hard disk and records the program executed by the CPU 801 or various data. A communication unit 809 communicates with an external apparatus via a network such as the Internet or a local area network or a wired or wireless communication medium such as digital broadcast. The computer apparatus 80 may acquire a program via the communication unit 809 and record the program on the ROM 802 or the recording unit 808.

When a removable medium 85 such as a magnetic disk, an optical disc, a magneto-optical disc, or a semiconductor memory is mounted, a drive 810 drives the removable medium 85 and acquires the recorded program, data, or the like. The acquired program or data is transmitted to the ROM 802, the RAM 803, or the recording unit 808, as necessary.

The CPU 801 reads and executes the program configured to perform the series of processes described above, and then performs the encoding process on an image signal recorded on the recording unit 808 or the removable medium 85 or an image signal supplied via the communication unit 809 or a decoding process on image compression information.

### <8. Case of Application to Electronic Apparatus>

As described above, the H.264/AVC scheme has been used as the encoding scheme/decoding scheme. However, the present technology can be also applied to an image encoding device/image decoding device that uses an encoding scheme/decoding scheme to perform other motion prediction and compensation processes.

Further, the present technology can be applied to an image encoding device and an image decoding device that is used when image information (bit stream) compressed by orthogonal transform such as discrete cosine transform and motion compensation, for example, as in MPEG, H.26x, or the like is received via a network medium such as satellite broadcast, a cable TV (television), the Internet, and a portable telephone or is used when processing is performed on a storage medium such as light, a magnetic disk, and a flash memory.

Next, electronic apparatuses to which the image encoding device 10 or the image decoding device 50 described above is applied will be described.

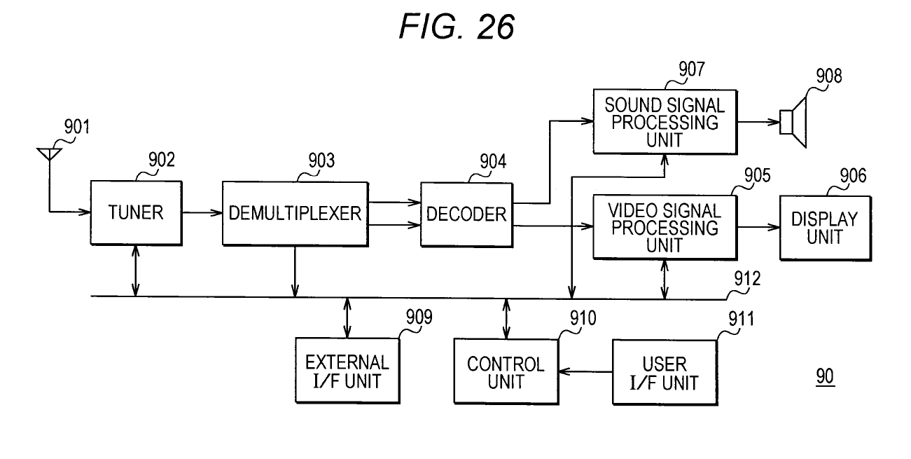

FIG. 26 is a diagram illustrating an example of the overall configuration of a television apparatus to which the present technology is applied. A television apparatus 90 includes an antenna 901, a tuner 902, a demultiplexer 903, a decoder 904, a video signal processing unit 905, a display unit 906, a sound signal processing unit 907, a speaker 908, and an external interface unit 909. The television apparatus 90 further includes a control unit 910, a user interface unit 911, and the like.

The tuner 902 selects a desired channel from a broadcast wave signal received by the antenna 901, performs demodulation, and outputs an obtained stream to the demultiplexer 903.

The demultiplexer 903 extracts packets of a video or an audio of a program to be viewed from the stream and outputs data of the extracted packets to the decoder 904. The demultiplexer 903 outputs the packets of the data such as EPG (Electronic Program Guide) to the control unit 910. Further, when scrambling is performed, the scrambling is cancelled by the demultiplexer or the like.

The decoder 904 performs a process of decoding the packets and outputs video data and audio data generated through the decoding process to the video signal processing unit 905 and the sound signal processing unit 907, respectively.

The video signal processing unit 905 removes noise of the video data and performs video processing or the like on the video data according to user's setting. The video signal processing unit 905 generates video data of a program to be displayed on the display unit 906, or image data or the like through a process based on application supplied via a network. The video signal processing unit 905 generates video data used to display a menu screen or the like for selection or the like of an item and superimposes the generated video data on the video data of the program. The video signal processing unit 905 generates a driving signal based on the video data generated in this way and drives the display unit 906.

The display unit 906 drives a display device (for example, a liquid crystal display element or the like) based on the driving signal from the video signal processing unit 905 and displays the video or the like of the program.

The sound signal processing unit 907 outputs an audio by performing a predetermined process such as noise removal on the audio data, performing a D/A conversion process or an amplification process on the processed audio data, and supplying the audio data to the speaker 908.

The external interface unit 909 is an interface that is connected to an external apparatus or a network, and transmits and receives data such as video data or audio data.

The user interface unit 911 is connected to the control unit 910. The user interface unit 911 includes an operation switch and a remote control signal receiving unit and supplies an operation signal according to a user's operation to the control unit 910.

The control unit 910 is configured to include a CPU (Central Processing Unit) or a memory. The memory stores a program to be executed by the CPU, various data necessary for the CPU to perform a process, EPG data, data acquired via the network, and the like. The program stored in the memory is read and executed at a predetermined timing such as an activation time of the television apparatus 90 by the CPU. The CPU controls each unit so that the television apparatus 90 can operate according to a user's operation by executing the program.

The television apparatus 90 further includes a bus 912 that connects the tuner 902, the demultiplexer 903, the video signal processing unit 905, the sound signal processing unit 907, the external interface unit 909, and the like to the control unit 910.

In the television apparatus having the above-described configuration, the decoder 904 is provided with a function of the image decoding device (image decoding method) according to this specification. Therefore, when the filter characteristics are switched according to the loop filter process on the reference image data and the predicted image data is generated in the image encoding process on a broadcast station side, the predicted image data can be generated by switching the filter characteristics in the image decoding process of the television apparatus, as in the broadcast station side. Accordingly, even when the image compression information is generated on the broadcast station side so that the deterioration in the quality of a predicted image can be reduced and the deterioration in the compression efficiency can be suppressed, the decoding process can be correctly performed by the television apparatus.

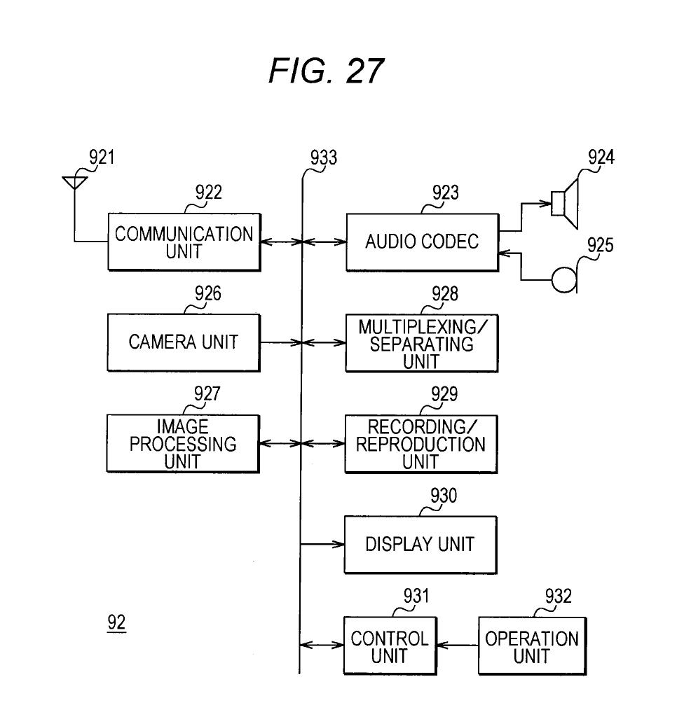

FIG. 27 is a diagram illustrating an example of the overall configuration of a portable telephone to which the present technology is applied. A portable telephone 92 includes a communication unit 922, an audio codec 923, a camera unit 926, an image processing unit 927, a multiplexing/separating unit 928, a recording/reproduction unit 929, a display unit 930, and a control unit 931. These units are connected to each other via a bus 933.

An antenna 921 is connected to the communication unit 922 and a speaker 924 and a microphone 925 are connected to the audio codec 923. Further, an operation unit 932 is connected to the control unit 931.

The portable telephone 92 performs various processes such as transmission and reception of a sound signal, transmission and reception of an electronic mail or image data, image photographing, and data recording in various modes such as an audio calling mode or a data communication mode.

In the audio calling mode, a sound signal generated by the microphone 925 is subjected to conversion to the audio data or data compression by the audio codec 923, and is supplied to the communication unit 922. The communication unit 922 generates a transmission signal by performing a modulation process, a frequency conversion process, or the like on the audio data. The communication unit 922 supplies the transmission signal to the antenna 921 to transmit the transmission signal to a base station (not illustrated). The communication unit 922 supplies audio data obtained by performing an amplification process, a frequency conversion process, a demodulation process, and the like on a received signal received by the antenna 921 to the audio codec 923. The audio codec 923 performs data decompression on the audio data or conversion to an analog sound signal and outputs the analog sound signal to the speaker 924.

When mail transmission is performed in the data communication mode, the control unit 931 receives character data input through an operation of the operation unit 932 and displays the input characters on the display unit 930. The control unit 931 generates mail data based on a user's instruction or the like in the operation unit 932 and supplies the mail data to the communication unit 922. The communication unit 922 transmits a transmission signal obtained by performing a modulation process, a frequency conversion process, or the like on the mail data from the antenna 921. The communication unit 922 restores the mail data by performing an amplification process or a frequency conversion process, a demodulation process, and the like on a received signal received by the antenna 921. The mail data is supplied to the display unit 930 to display the mail contents.

The portable telephone 92 can cause the recording/reproduction unit 929 to store the received mail data in a storage medium. The storage medium is any rewritable storage medium. Examples of the storage medium include a semiconductor memory such as a RAM or a built-in flash memory and a removable medium such as a hard disk, a magnetic disk, a magneto-optical disc, an optical disc, a USB memory, or a memory card.

When the image data is transmitted in the data communication mode, the image data generated by the camera unit 926 is supplied to the image processing unit 927. The image processing unit 927 generates image compression information by performing an encoding process on the image data.

The multiplexing/separating unit 928 multiplexes the image compression information generated by the image processing unit 927 and the audio data supplied from the audio codec 923 according to a predetermined scheme and supplies the multiplexed data to the communication unit 922. The communication unit 922 transmits a transmission signal obtained by performing a modulation process, a frequency conversion process, or the like on the multiplexed data from the antenna 921. The communication unit 922 restores the multiplexed data by performing an amplification process, a frequency conversion process, a demodulation process, and the like on a received signal received by the antenna 921. The multiplexed data is supplied to the multiplexing/separating unit 928. The multiplexing/separating unit 928 separates the multiplexed data and supplies the image compression information and the audio data to the image processing unit 927 and the audio codec 923, respectively.

The image processing unit 927 generates image data by performing a decoding process on the image compression information. The image data is supplied to the display unit 930 to display the received image. The audio codec 923 converts the audio data into an analog sound signal and supplies the analog sound signal to the speaker 924 to output the received audio.

In the portable telephone apparatus with the above-described configuration, the image processing unit 927 is provided with the function of the image processing device (image processing method) according to this specification. Accordingly, for example, by switching the filter characteristics according to the loop filter process on the reference image data in the encoding process on an image to be transmitted, the deterioration in the quality of a predicted image can be reduced and the deterioration in the compression efficiency can be suppressed. Further, since the predicted image data can be generated by switching the filter characteristics in the decoding process on a received image, as in the encoding process, the decoding process can be correctly performed.

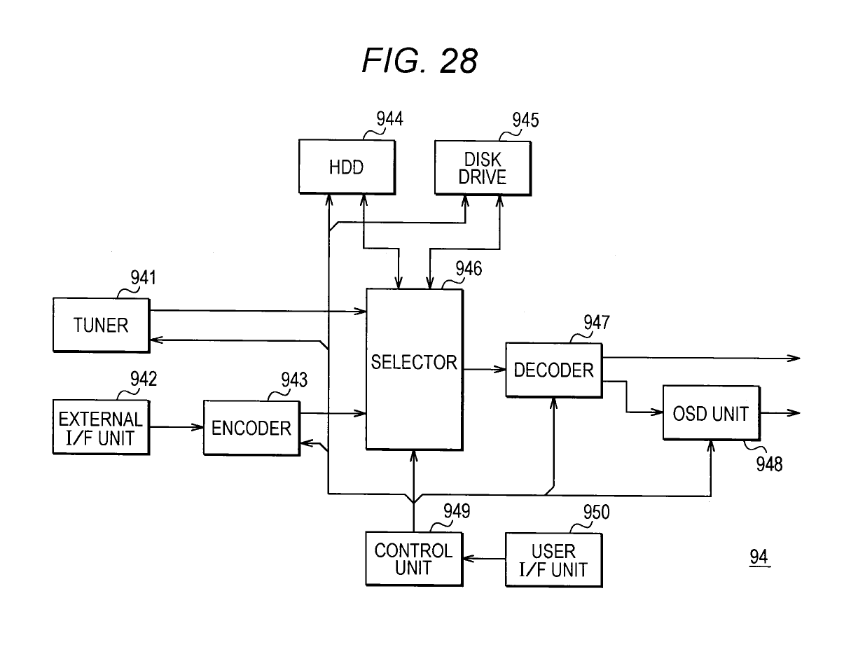

FIG. 28 is a diagram illustrating an example of the overall configuration of a recording/reproduction apparatus to which the present technology is applied. For example, a recording/reproduction apparatus 94 records audio data and video data of a received broadcast program on a recording medium and supplies the recorded data to a user at a timing according to a user's instruction. For example, the recording/reproduction apparatus 94 can acquire audio data or video data from another apparatus and record the audio data and the video data on a recording medium. The recording/reproduction apparatus 94 is configured to display an image on a monitor apparatus or the like or output an audio by decoding and outputting audio data and video data recorded on a recording medium.

The recording/reproduction apparatus 94 includes a tuner 941, an external interface unit 942, an encoder 943, an HDD (Hard Disk Drive) unit 944, a disk drive 945, a selector 946, a decoder 947, an OSD (On-Screen Display) unit 948, a control unit 949, and a user interface unit 950.

The tuner 941 selects a desired channel from a broadcast signal received by an antenna (not illustrated). The tuner 941 outputs image compression information obtained by demodulating the received signal of the desired channel to the selector 946.

The external interface unit 942 includes at least one of an IEEE 1394 interface, a network interface unit, a USB interface, a flash memory interface, and the like. The external interface unit 942 is an interface that is connected to an external apparatus, a network, a memory card, or the like and receives data such as video data or audio data to be recorded.

When the video data or the audio data supplied from the external interface unit 942 is not encoded, the encoder 943 performs an encoding process according to a predetermined scheme and outputs image compression information to the selector 946.

The HDD unit 944 records contents data such as a video or an audio, various programs, other data, or the like on a built-in hard disk and reads the data from the hard disk, for example, when the data is reproduced.

The disk drive 945 records and reproduces a signal on a mounted optical disc. Examples of the optical disc include a DVD disk (DVD-Video, DVD-RAM, DVD-R, DVD-RW, DVD+R, DVD+RW, or the like) and a Blu-ray disk.

When a video or an audio is recorded, the selector 946 selects one of the streams from the tuner 941 or the encoder 943 and supplies the selected stream to one of the HDD unit 944 and the disk drive 945. When a video or an audio is reproduced, the selector 946 supplies a stream output from the HDD unit 944 or the disk drive 945 to the decoder 947.

The decoder 947 performs a decoding process on the stream. The decoder 947 supplies video data generated by performing the decoding process to the OSD unit 948. The decoder 947 outputs audio data generated by performing the decoding process.

The OSD unit 948 generates the video data configured to display a menu screen or the like for selection or the like of an item, superimposes the video data on video data output from the decoder 947, and outputs the superimposed video data.

The user interface unit 950 is connected to the control unit 949. The user interface unit 950 includes an operation switch and a remote control signal receiving unit and supplies an operation signal according to a user's operation to the control unit 949.

The control unit 949 is configured to include a CPU, a memory, or the like. The memory stores a program to be executed by the CPU and various data necessary for the CPU to perform a process. The program stored in the memory is read and executed at a predetermined timing such as an activation time of the recording/reproduction apparatus 94 by the CPU. The CPU controls each unit so that the recording/reproduction apparatus 94 can operate according to a user's operation by executing the program.

In the recording/reproduction apparatus having the above-described configuration, the encoder 943 is provided with the function of the image processing device (image processing method) according to this specification. Accordingly, for example, by switching the filter characteristics according to the loop filter process on the reference image data in the encoding process when an image is recorded, the deterioration in the quality of a predicted image can be reduced, and thus the deterioration in the compression efficiency can be suppressed. Further, since the predicted image data can be generated by switching the filter characteristics in the decoding process on the recorded image, as in the encoding process, the decoding process can be correctly performed.

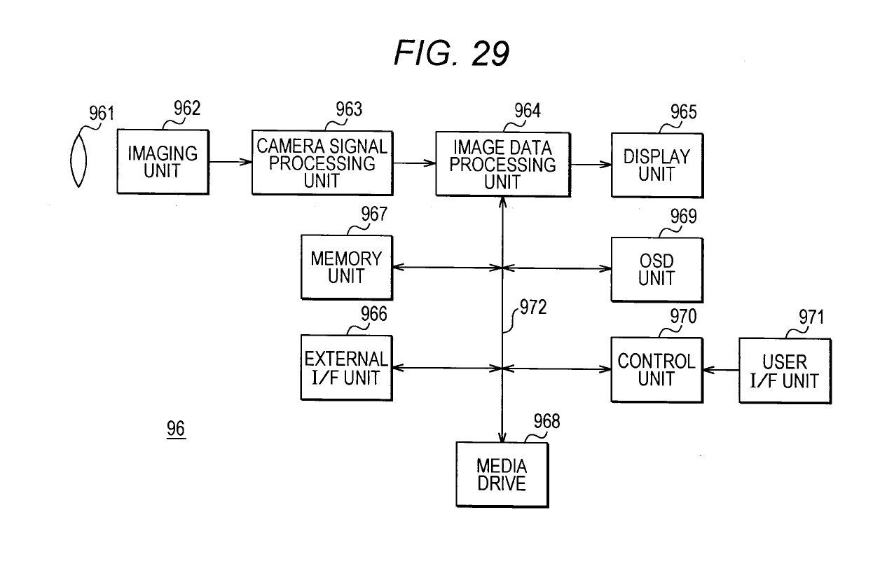

FIG. 29 is a diagram illustrating an example of the overall configuration of an imaging apparatus to which the present technology is applied. An imaging apparatus 96 images a subject, displays an image of the subject on a display unit, and records the image as image data on a recording medium.

The imaging apparatus 96 includes an optical block 961, an imaging unit 962, a camera signal processing unit 963, an image data processing unit 964, a display unit 965, an external interface unit 966, a memory unit 967, a media drive 968, an OSD unit 969, and a control unit 970. A user interface unit 971 is connected to the control unit 970. The image data processing unit 964, the external interface unit 966, the memory unit 967, the media drive 968, the OSD unit 969, the control unit 970, and the like are connected to each other via a bus 972.

The optical block 961 is configured using a focus lens, a diaphragm mechanism or the like. The optical block 961 forms an optical image of a subject on an imaging surface of the imaging unit 962. The imaging unit 962 is configured using a CCD or CMOS image sensor, generates an electric signal according to the optical image through photoelectric conversion, and supplies the electric signal to the camera signal processing unit 963.

The camera signal processing unit 963 performs various kinds of camera signal processing such as knee correction, gamma correction, or color correction on the electric signal supplied from the imaging unit 962. The camera signal processing unit 963 supplies the image data obtained after the camera signal processing to the image data processing unit 964.

The image data processing unit 964 performs an encoding process on the image data supplied from the camera signal processing unit 963. The image data processing unit 964 supplies image compression information generated by performing the encoding process to the external interface unit 966 or the media drive 968. The image data processing unit 964 performs a decoding process on the image compression information supplied from the external interface unit 966 or the media drive 968. The image data processing unit 964 supplies the image data generated by performing the decoding process to the display unit 965. The image data processing unit 964 supplies the image data supplied from the camera signal processing unit 963 to the display unit 965, or superimpose display data acquired from the OSD unit 969 on the image data and supplies the superimposed data to the display unit 965.

The OSD unit 969 generates display data such as a menu screen or an icon including signs, characters, or graphics and outputs the display data to the image data processing unit 964.

For example, the external interface unit 966 includes an USB input/output terminal or the like and is connected to a printer when an image is printed. A drive is connected to the external interface unit 966, as necessary, a removable medium such as a magnetic disk or an optical disc is appropriately mounted, a program read from the removable medium is installed, as necessary. Further, the external interface unit 966 includes a network interface connected to a predetermined network such as a LAN or the Internet. For example, the control unit 970 reads the image compression information from the memory unit 967 in response to an instruction from the user interface unit 971 and supplies the image compression information from the external interface unit 966 to another apparatus connected via a network. The control unit 970 can acquire the image compression information or the image data supplied from another apparatus via the network via the external interface unit 966 and can supply the image compression information or the image data to the image data processing unit 964.

As a recording medium driven by the media drive 968, for example, any removable medium, such as a magnetic disk, a magneto-optical disc, an optical disc, or a semiconductor memory, capable of performing reading and writing is used. As the recording medium, any kind of removable medium may be used, a tape device may be used, a disk may be used, or a memory card may be used. Of course, a contactless IC card or the like may be used.

The media drive 968 and the recording medium may be integrated so as to be configured by, for example, a non-portable storage medium such as a built-in hard disk drive or an SSD (Solid State Drive).

The control unit 970 may be configured using a CPU, a memory, or the like. The memory stores a program to be executed by the CPU and various data necessary for the CPU to perform a process. The program stored in the memory is read and executed at a predetermined timing such as an activation time of the imaging apparatus 96 by the CPU. The CPU controls each unit so that the imaging apparatus 96 can operate according to a user's operation by executing the program.

In the imaging apparatus having the above-described configuration, the image data processing unit 964 is provided with the function of the image processing device (image processing method) according to this specification. Accordingly, by switching the filter characteristics according to the loop filter process on the reference image data in the encoding process when a photographed image is recorded on the memory unit 967, a recording medium, or the like, the deterioration in the quality of a predicted image can be reduced, and thus the deterioration in the compression efficiency can be suppressed. Further, since the predicted image data can be generated by switching the filter characteristics in the decoding process on the recorded image, as in the encoding process, the decoding process can be correctly performed.

The present technology should not be construed to be limited to the above-described embodiment. The embodiment discloses the present technology as an exemplified form, and thus it is apparent to those skilled in the art that the embodiment may be corrected or substituted within the scope of the present technology without departing from the gist of the present technology. That is, to determine the gist of the present technology, the claims should be considered.

The image processing device according to the present technology may be configured as follows.

(1) An image processing device includes: a loop filter unit that executes a filter process on reference image data referred to by a current block; an interpolation filter unit that generates predicted image data using the reference image data and a motion vector corresponding to the current block; and a filter control unit that switches a filter coefficient of an interpolation filter according to the filter process performed by the loop filter unit on the reference image data used by the interpolation filter.

(2) In the image processing device described in (1), the filter control unit may switch the filter coefficient when the filter process is not performed by the loop filter unit to a coefficient in which noise removal strength is enhanced more than that of the filter coefficient when the filter process is performed.

(3) In the image processing device described in (1) or (2), the interpolation filter unit may perform a low-frequency pass filter process as the noise removal.

(4) In the image processing device described in any one of (1) to (3), the filter process of the loop filter unit may include at least one of a deblocking filter process and an adaptive loop filter process.

(5) In the image processing device described in any one of (1) to (4), the loop filter unit may perform adaptively performs an offset process. The filter control unit may set the filter coefficient not subjected to the offset process as a coefficient in which noise removal strength is enhanced more than that of the filter coefficient subjected to the offset process.

### INDUSTRIAL APPLICABILITY

In an image processing device and an image processing method according to the present technology, a loop filter unit executes a filter process on reference image data referred to by a current block. An interpolation filter unit generates predicted image data using the reference image data and a motion vector corresponding to the current block. A filter control unit switches a filter coefficient of an interpolation filter according to the filter process performed by the loop filter unit on the reference image data used by the interpolation filter. Therefore, when the filter process is not performed by the loop filter unit, a predicted image data in which noise is small can be generated, for example, by causing the interpolation filter unit to perform the filter process on the reference image data by the filter characteristics in which noise removal strength is enhanced. Thus, the deterioration in the quality of a predicted image can be reduced, and thus the deterioration in the compression efficiency can be suppressed. Accordingly, the present technology is suitable for the image encoding device, the image decoding device, or the like used when the image compression information (bit stream) obtained by performing encoding in units of blocks is transmitted and received via a network medium such as satellite broadcast, a cable TV, the Internet, and a portable telephone or is used when processing is performed on a storage medium such as light, a magnetic disk, and a flash memory.

### REFERENCE SIGNS LIST

10 Image encoding device
11 A/D conversion unit
12, 57 Screen rearrangement buffer
13 Subtraction unit
14 Orthogonal transform unit
15 Quantization unit
16 Lossless quantization unit
17, 51 Accumulation buffer
18 Rate control unit
21, 53 Inverse quantization unit
22, 54 Inverse orthogonal transform unit
23, 55 Addition unit
24, 56 Loop filter unit
25, 61 Frame memory
31, 71 Intra-prediction unit
32 Motion prediction/compensation unit
33 Predicted image/optimum mode selection unit
50 Image decoding device
52 Lossless decoding unit
58 D/A conversion unit
62, 73 Selector
72 Motion compensation unit
80 Computer apparatus
90 Television apparatus
92 Portable telephone
94 Recording/reproduction apparatus
96 Imaging apparatus
241, 561 Deblocking filter unit
242, 562 ALF unit
245, 565 SAO unit
321 Motion detection unit
322 Mode determination unit
323, 722 Motion compensation processing unit
324, 723 Motion vector buffer
721 Motion vector synthesizing unit
3231, 7221 Compensation control unit
3231a ALF information memory
3232, 7222 Coefficient table
3233, 7223 Filter unit

1. An image processing device comprising:
a loop filter unit that executes a filter process on reference image data referred to by a current block;
an interpolation filter unit that generates predicted image data using the reference image data and a motion vector corresponding to the current block; and
a filter control unit that switches a filter coefficient of an interpolation filter according to the filter process performed by the loop filter unit on the reference image data used by the interpolation filter.

2. The image processing device according to claim 1, wherein the filter control unit switches the filter coefficient when the filter process is not performed by the loop filter unit to a coefficient in which noise removal strength is enhanced more than that of the filter coefficient when the filter process is performed.

3. The image processing device according to claim 2, wherein the interpolation filter unit performs a low-frequency pass filter process as the noise removal.

4. The image processing device according to claim 1, wherein the filter process of the loop filter unit includes at least one of a deblocking filter process and an adaptive loop filter process.

5. The image processing device according to claim 1,
wherein the loop filter unit adaptively performs an offset process, and
wherein the filter control unit sets the filter coefficient not subjected to the offset process as a coefficient in which noise removal strength is enhanced more than that of the filter coefficient subjected to the offset process.

6. An image processing method comprising the steps of:
executing a filter process on reference image data referred to by a current block;
generating predicted image data using the reference image data and a motion vector corresponding to the current block; and
switching a filter coefficient of the generating of the predicted image data according to the filter process in the executing of the filter process on the reference image data used in the generating of the predicted image data.
